(19) United States
(12) Patent Application Publication
(10) Pub. No.: US 2024/0270980 A1
(43) Pub. Date: Aug. 15, 2024

(54) METHODS, COMPOSITIONS, AND APPARATUSES FOR SUPERHYDROPHOBIC POLYMER COATINGS AND SUPERAMPHIPHOBIC COATINGS OF METAL SURFACES

(71) Applicant: West Virginia University Board of Governors on Behalf of West Virginia University, Morgantown, WV (US)

(72) Inventors: Tarek R. FARHAT, Beckley, WV (US); Hasan M. El RIFAI, Daniels, WV (US); Rana M. JISR, Daniels, WV (US)

(21) Appl. No.: 18/439,554

(22) Filed: Feb. 12, 2024

Related U.S. Application Data
(60) Provisional application No. 63/444,896, filed on Feb. 10, 2023.

(51) Int. Cl. C09D 5/16; C09D 127/18; C09D 139/02; G01N 21/03; G01N 21/33

(52) U.S. Cl. CPC C09D 5/1668; C09D 127/18; C09D 139/02; G01N 21/03; G01N 21/33; G01N 2021/0389

(57) ABSTRACT

In one aspect, the disclosure relates to coated metal materials, e.g., a metal substrate such as a solid metal surface or a metal mesh, coated with a superhydrophobic coating comprising a first layer and a second layer as disclosed herein; methods of making the coated metal materials comprising the superhydrophobic coating; and products comprising the disclosed coated metals. In another aspect, the disclosure relates to an apparatus comprising a metal mesh coated with a superamphiphobic or superhydrophobic coating. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/444,896, filed on Feb. 10, 2023, which is incorporated herein by reference in its entirety.

### STATEMENT REGARDING FEDERALLY SPONSORED RESEARCH

This disclosure was made with U.S. Government support under grant number 80NSSC22M0027, awarded by the National Aeronautics and Space Administration. The U.S. Government has certain rights in the disclosure.

### BACKGROUND

Wetting, or wettability, of a surface is an important trait in materials for modern technology which is affected by the chemical and structural composition of a material. The need for hydrophobic and/or amphiphobic coatings is especially of interests in many industries such as windshield wipers, cell phone covers, ship hulls, and microfluidic channels. A liquid forms into droplets on hydrophobic or amphiphobic surfaces when the adhesive forces within the liquid are greater than the cohesive forces between the surface of the material and the liquid.

Despite advances in research directed to providing superhydrophobic coatings on metal materials, there is still a scarcity of superhydrophobic coatings having the desired properties, cost, and production efficiencies. These needs and other needs are satisfied by the present disclosure.

### SUMMARY

In accordance with the purpose(s) of the disclosure, as embodied and broadly described herein, the disclosure, in one aspect, relates to coated metal materials, e.g., a metal substrate such as a solid metal surface or a metal mesh, coated with a superhydrophobic coating comprising a first layer and a second layer as disclosed herein; methods of making the coated metal materials comprising the superhydrophobic coating; and products comprising the disclosed coated metals. In another aspect, the disclosure relates to an apparatus comprising a metal mesh coated with a superamphiphobic or superhydrophobic coating.

Disclosed are coated metals comprising: a metal substrate; and a superhydrophobic coating comprising a bilayer coating comprising a first layer and a second layer; wherein the first layer comprises a polyelectrolyte; wherein the second layer comprises particles of polytetrafluoroethylene; wherein the first layer is deposited on the metal substrate; and wherein the second layer is deposited on the first layer.

In further aspects, the superhydrophobic coating can comprise more than one bilayer coating comprising the first layer and the second layer, e.g., multiple, successive bilayer coatings in which bilayer coating comprises a first layer and a second layer.

Also disclosed herein are methods of making the disclosed coated metal comprising the superhydrophobic coating, the method comprising the steps of: forming superhydrophobic coating comprising a first layer and a second layer; wherein the forming the superhydrophobic coating comprises depositing the first layer on the metal substrate; wherein the forming the superhydrophobic coating comprises depositing the second layer on the first layer; wherein the first layer comprises a polyelectrolyte; wherein the second layer comprises particles of polytetrafluoroethylene; wherein the depositing the first layer on the metal substrate comprises contacting the metal substrate with a solution of the polyelectrolyte comprising: from about 1 mM to about 100 mM in the polyelectrolyte; and from about 1 mM to about 1000 mM salt; wherein the depositing the second layer on the first layer comprises contacting the metal substrate comprising the first layer with a colloidal solution of the polytetrafluoroethylene; and wherein the colloidal solution of the polytetrafluoroethylene comprises about 1 wt % to about 60 wt % of the polytetrafluoroethylene.

Also disclosed herein is an apparatus comprising a base; a first wall, wherein the first wall extends perpendicularly from the base; a second wall, wherein the second wall extends perpendicularly from the base and is parallel with the first wall; a third wall, wherein the third wall extends perpendicularly from the base and extends between the first wall and the second wall; and a fourth wall, wherein the fourth wall extends perpendicularly from the base, extends between the first wall and the second wall, and is parallel to the third wall; wherein, a portion of the first wall comprises a first opening covered by a first mesh wire; a portion of the second wall comprises a second opening covered by a second mesh wire, wherein the first opening is aligned with the second opening; wherein the first mesh wire comprises a superhydrophobic or superamphiphobic coating; and wherein the second mesh wire comprises a superhydrophobic or superamphiphobic coating.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C show various substrate representative geometries. FIG. 1A shows the end of a glass pipe (GP) of 1.3 cm diameter, FIG. 1B shows a metallic plate (top) and a round spoon (RS) of 1.5 cm diameter, 0.5-1.0 cm depth (bottom), and FIG. 1C shows a mini bucket (MB) of 1.2 cm diameter with a 2.0-2.5 cm height.

FIG. 2 shows a representative schematic of the deposition of polyallylamine hydrochloride (PAH) on a wire mesh substrate followed by a polytetrafluoroethylene (PTFE) colloidal particles layer to form one bilayer.

FIG. 3 shows a representative FTIR spectrum of the coated SS304 120 mesh substrate with characteristic two-strong peaks of the F-C stretch band at 1150 cm⁻¹ and 1200 cm⁻¹. The number of bilayers increases from one bilayer (a), to two bilayers (b), to three bilayers (c).

FIGS. 4A-4B show representative Scanning Electron Microscopy images of uncoated SS304 wire mesh (FIG. 4A) and one bilayer (FIG. 4B), two bilayer (FIG. 4C), and three bilayer (FIG. 4D) PTFE/PAH coated SS304 wire mesh. Magnification: 900 to 1400, HV=5 KV at a vacuum pressure of 0.1 Pa, Detector: BSD Full.

FIGS. 5A-5B show a representative simplified schematic of 1 μm size colloidal particles that sets C˜λ (FIG. 5A) and a liquid drop on a wire mesh (FIG. 5B).

FIGS. 6A-6C show representative sessile drop photos of a water droplet on uncoated solid flat substrates of carbon steel (FIG. 6A), stainless steel SS304 plate (FIG. 6B), and aluminum plate (FIG. 6C).

FIGS. 7A-7C show representative sessile drop photos of a water droplet on PAH-PTFE coated metallic plates of carbon steel (FIG. 7A), stainless steel SS304 plate (FIG. 7B) and aluminum plate (FIG. 7C). Droplet size ˜20 μL.

FIGS. 8A-8D show representative sessile drop photos of a water droplet on selected SS304 wire mesh samples that are coated with a bilayer of PAH/PTFE, droplet size ˜20 μL: wire mesh 16 (FIG. 8A), wire mesh 38 (FIG. 8B), wire mesh 70 (FIG. 8C), and wire mesh 120 (FIG. 8D).

FIGS. 9A-9C show representative PAH/PTFE coated SS304 wire mesh articles.

FIG. 9A shows a representative PAH/PTFE coated SS304 wire mesh 120 used to cap a glass pipe filled with pure water. FIGS. 9B-9C show representative PAH/PTFE coated SS304 wire mesh 120 mini buckets used to retain acid and base solutions (FIG. 9B) and retain pure water and salt solutions (FIG. 9C).

FIGS. 10A-10B show representative aspects of a coated mesh wire. FIG. 10A shows a mesh wire cuvette with mesh wire window showing the path of the UV-Vis radiation.

FIG. 10B shows a Scanning Electron Microscopy image showing the coated surface of the mesh #38wire.

FIG. 11 shows representative UV-Vis spectra of various empty cuvettes vs Air: (a) glass cuvette (GC), (b) quartz cuvette (QC), and (c) mesh wire cuvette (MWC).

FIG. 12 shows a representative UV-Vis spectrum of an empty MWC against an empty MWC.

FIGS. 13A-13B show representative UV-Vis background spectra of GC water vs GC water (FIG. 13A) and typical QC water vs QC water (FIG. 13B), or MWC water vs MWC water to verify zero background and minimum impurity level.

FIG. 14 shows representative UV-Vis spectra of Caffeine solutions using a glass cuvette at three different concentrations, (a) 200 mg/L, (b) 100 mg/L, and (c) 50 mg/L, with λₘₐₓ=284 nm.

FIG. 15 shows representative UV-Vis spectra of Caffeine solutions using a quartz cuvette at three different concentrations, (a) 200 mg/L, (b) 100 mg/L, and (c) 50 mg/L, at λₘₐₓ₁=277 nm and λₘₐₓ₂=208 nm.

FIG. 16 shows representative UV-Vis spectra of Caffeine solutions using a mesh wire cuvette at three different concentrations, (a) 200 mg/L, (b) 100 mg/L, and (c) 50 mg/L, at λₘₐₓ1=277 nm and λₘₐₓ₂=208 nm.

FIG. 17 shows representative UV-Vis spectra of hydrochloric acid solutions using a glass cuvette at two different concentrations, (a) 36 mg/L and (b) 18 mg/L. The decaying signal characteristic of the HCl solution is completely masked by the cut-off at 250 nm.

FIG. 18 shows representative UV-Vis spectra of hydrochloric acid solutions using a quartz cuvette at two different concentrations, (a) 36 mg/L and (b) 18 mg/L.

FIG. 19 shows representative UV-Vis spectra of hydrochloric acid solutions using a mesh wire cuvette at two different concentrations, (a) 36 mg/L and (b) 18 mg/L.

FIG. 20 shows representative UV-Vis spectra of chromate solutions using a glass cuvette at three different concentrations, (a) 2.4 mM, (b) 1.2 mM, and (c) 0.6 mM.

FIG. 21 shows representative UV-Vis spectra of chromate solutions using a quartz cuvette at three different concentrations, (a) 2.4 mM, (b) 1.2 mM, and (c) 0.6 mM.

FIG. 22 shows representative UV-Vis spectra of chromate solutions using a mesh wire cuvette at three different concentrations, (a) 2.4 mM, (b) 1.2 mM, and (c) 0.6 mM.

FIGS. 23A-23C show three representative different views of an apparatus including a coated mesh wire, in accordance with various aspects of the present disclosure.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a PAH,” “a PTFE,” or “a metal substrate,” includes, but is not limited to, two or more such PAH polymers, PTFE polymers, or metal substrates, and the like.

Reference to “a/an” chemical compound, polymer, or metal material each refers to one or more molecules of the chemical compound, polymer, and metal material rather than being limited to a single molecule of the chemical compound, polymer, and metal material. Furthermore, the one or more molecules may or may not be identical, so long as they fall under the category of the chemical compound, protein, and antibody. Thus, for example, “a polymer” is interpreted to include one or more polymer molecules of the polymer, where the antibody molecules may or may not be identical (e.g., different molecular weights within a molecular weight distribution characteristic of the polymer).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated+10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “contacting” as used herein refers to bringing a disclosed polymer, compound, chemical, or material in proximity to another disclosed polymer, compound, chemical, or material as indicated by the context. For example, a polymer contacting metal material refers to the polymer being in proximity to the metal material by the polymer interacting and binding to the metal material via ionic, dipolar and/or van der Waals interactions. In some instances, contacting can comprise both physical and chemical interactions between the indicated components. It is to be understood that chemical interactions can comprise a combination of covalent and non-covalent interactions, including one or more of ionic, dipolar, van der Waals interactions, and the like. For example, a layer contacting a substrate layer is understood to mean that the layer is in physical and chemical contact with the substrate layer that can comprise covalent, ionic, and non-covalent interactions.

As used herein, the term “effective amount” refers to an amount that is sufficient to achieve the desired modification of a physical property of the composition or material. For example, an “effective amount” of a polyelectrolyte refers to an amount that is sufficient to achieve the desired improvement in the property modulated by the formulation component, e.g., achieving the desired level of interaction with a metal substrate and a second layer comprising a PTFE. The specific level in terms of wt % in a composition required as an effective amount will depend upon a variety of factors including the amount and type of polyelectrolyte, type of metal material, amount and type of the PTFE, and end use of the article made using the composition.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

### B. REFERENCE NUMBERS

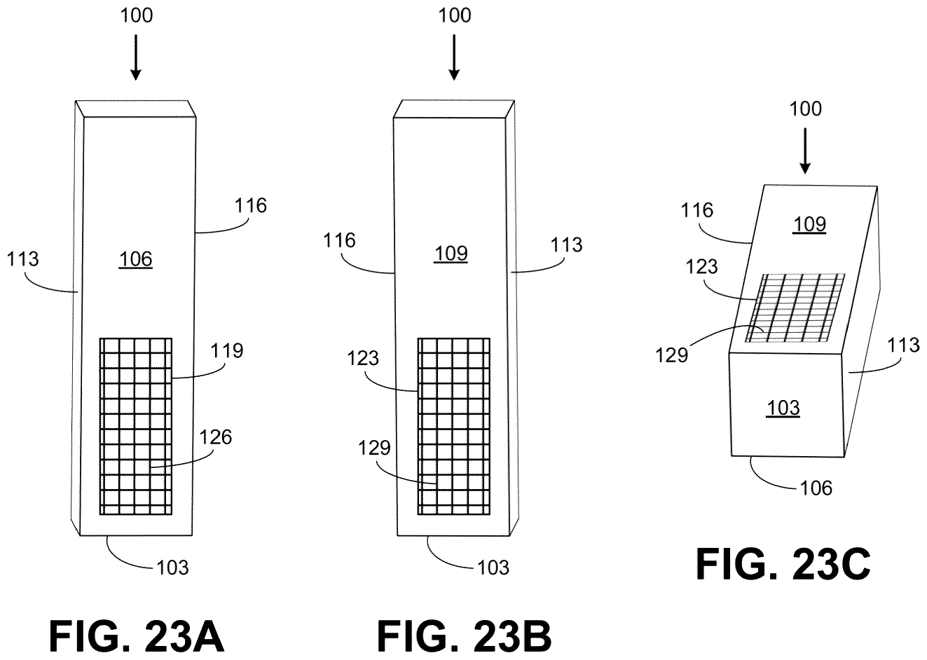

The following table, Table 1, of reference numbers is provided for convenience only and lists the various reference numbers and their description as used herein and as shown in FIGS. 23A-23C. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. It is understood that, in a given figure, like numbers referring to a given element, assembly, or component have like numbers and functions in the same figure or other figures as used herein. That is, like reference numerals designate corresponding parts throughout the several views. In the drawings, the size and relative sizes of layers and regions may be exaggerated for clarity. Moreover, it is further understood that various modifications and variations can be made to a given reference number referring to a given element, assembly, or component without departing from the scope or spirit of the described element, assembly, or component.

TABLE 1
List of Reference Characters Used in Drawings

| Reference Character | Description |
|---|---|
| 100 | apparatus |
| 103 | base |
| 106 | first wall |
| 109 | second wall |
| 113 | third wall |
| 116 | fourth wall |
| 119 | first opening |
| 123 | second opening |
| 126 | first wire mesh |
| 129 | second wire mesh |

### C. SUMMARY

Superhydrophobic films or coatings are an extensive area of research with a variety of applications. In corrosion protection, a superhydrophobic coating deprives the process of corrosion from water. For filtration and aqua systems, the repelling characteristics of superhydrophobic films initiate precipitation or vaporization of water. The theory of superhydrophobic surfaces is based on having a low surface energy coating on a rough surface [1,2]. From the various conventional techniques that are used to design superhydrophobic coatings, one technique utilizes the sequential deposition of one bilayer and up to three bilayers used in polyelectrolyte multilayer (PEM) techniques to design ultrathin films. Previous work on the PEM technique used polyelectrolytes (PE) with colloidal particles or hydrophobic PEs to create superhydrophobic coatings [3,4,5,6]. When the polyelectrolyte polyallylamine hydrochloride PAH is used to design hydrophobic coatings, it is usually coupled with an anionic PE (e.g., polystyrene sulfonate PSS or polyacrylic acid PAA) and silica particles to deposit a PEM film. The film is then capped with a hydrophobic polymer (e.g., perfluorooctyl silane, [7]) to attain superhydrophobic nature. In fact, silica is used extensively in providing the roughness required to design a superhydrophobic coating [8]. The polymer polytetrafluoroethylene PTFE was used as a flexible substrate to support a superhydrophobic coating for biochemical applications, but the PTFE substrate was not part of the hydrophobic ceramic coating [9]. Hydrophobic coating layers with high transmittance were fabricated by optimizing the PTFE colloid content in alumina [10]. Ultra-hydrophobic films were made from titanium dioxide nanoparticles that were fluorinated by the thermal decomposition of polytetrafluoroethylene in a nitrogen atmosphere [11]. Other techniques roughened the smooth surface of the PTFE substrate by Ar-ion bombardment to design an Ultra-hydrophobic surface [12].

In the present disclosure, e.g., the Examples, the depositing of a PTFE colloid on a metal surface is carried out at room temperature under aqueous conditions, which is a significant improvement upon currently available conventional techniques. The techniques disclosed herein did not use any ceramic powders, thermal annealing, ion-bombardment, or specialty fluorinated molecules to attain a superhydrophobic character. Instead, a metal surface was functionalized by a PAH polyelectrolyte layer followed by one layer of PTFE colloid to design the superhydrophobic coating. Sequential deposition of PAH/PTFE ultrathin film on metallic substrates can be achieved if the deposited film is not left to dry. Up to three bilayers of PAH/PTFE were deposited and characterized. Two types of metallic substrates were used to deposit the PAH/PTFE thin films. The first type of substrates used degreased plates of stainless steel SS304, carbon steel, and aluminum. The second type of substrates used mesh substrates of stainless steel 304 (mesh numbers 16, 38, 70, 120), and aluminum mesh #20. Characterization of the deposited PAH/PTFE thin films on the metallic substrates was made using Fourier Transform infrared FTIR, Contact Angle Measurements CAM, and Scanning Electron Microscopy SEM.

Herein described and disclosed is a coated metal comprising a metal substrate and a superhydrophobic coating comprising a bilayer coating comprising a first layer and a second layer; wherein the first layer comprises a polyelectrolyte; wherein the second layer comprises particles of polytetrafluoroethylene; wherein the first layer is deposited on the metal substrate; and wherein the second layer is deposited on the first layer.

Also disclosed herein is a method of making a disclosed coated metal, comprising forming a superhydrophobic coating comprising a first layer and a second layer; wherein the forming the superhydrophobic coating comprises depositing the first layer on a metal substrate; wherein the forming the superhydrophobic coating comprises depositing the second layer on the first layer; wherein the first layer comprises a polyelectrolyte; wherein the second layer comprises particles of polytetrafluoroethylene; wherein the depositing the first layer on the metal substrate comprises contacting the metal substrate with a solution of the polyelectrolyte comprising from about 1 mM to about 100 mM of the polyelectrolyte and from about 1 mM to about 1000 mM salt; wherein the depositing the second layer on the first layer comprises contacting the metal substrate comprising the first layer with a colloidal solution of the polytetrafluoroethylene; and wherein the colloidal solution of the polytetrafluoroethylene comprises about 1 wt % to about 60 wt % of the polytetrafluoroethylene.

Also disclosed herein is an apparatus comprising a base; a first wall, wherein the first wall extends perpendicularly from the base; a second wall, wherein the second wall extends perpendicularly from the base and is parallel with the first wall; a third wall, wherein the third wall extends perpendicularly from the base and extends between the first wall and the second wall; and a fourth wall, wherein the fourth wall extends perpendicularly from the base, extends between the first wall and the second wall, and is parallel to the third wall; wherein, a portion of the first wall comprises a first opening covered by a first mesh wire; a portion of the second wall comprises a second opening covered by a second mesh wire, wherein the first opening is aligned with the second opening; wherein the first mesh wire comprises a superhydrophobic or superamphiphobic coating; and wherein the second mesh wire comprises a superhydrophobic or superamphiphobic coating. In one aspect, the apparatus is a cuvette or optical sample cell comprising a disclosed coated metal or a coated metal made by a disclosed process.

Cuvettes or optical sample cells are used in UV-Vis and Far UV spectroscopy and come in various geometries and structures [21,22], however, these cuvettes share one common feature. All cuvettes have two-facing optically transparent windows that allow radiation in the UV-Vis and Far UV regions to pass through based on the material used. The transparent windows can be glass, quartz, or other ceramics transparent to UV-Vis and Far UV radiation. For example, fused silica has a transmission window with a minimum cut-off wavelength of 150 nm followed by Quartz at 190 nm, while glass and plastic are limited to wavelengths longer than 300 nm [21,22,23]. With this wavelength range limitation, most UV-Vis spectrometers are designed to operate between 190 nm to 1200 nm [23,24,25]. Bringing in a sample cell that can operate in the UV-Vis and Far UV regions down to 100 nm can have a remarkable impact in this spectroscopy domain. Advances in the Far UV region and its potential applications in the region of 100 nm to 200 nm have been previously addressed [26,27]. To go around the limitations imposed by conventional cuvettes, researchers who investigate instrument performance have applied attenuated internal reflection ATR spectroscopy in the Far UV region to probe samples in the 150 to 200 nm region [26,27,28]. Near 190 nm region, conventional UV-Vis can probe common ions such as Cl⁻(aq), NO₃⁻(aq), NH₃(aq), and the like at a low detection level of 100 to 10 ppm [29,30].

There are optical materials or ceramics that are designed for vacuum UV (VUV) instruments that can be transmissive down to ˜160 nm. However, in general, these optical materials are moist sensitive and mostly have applications as optical windows and not cuvettes [21,22,23]. Optical materials that are used by cuvettes suffer from reflection and scattering losses. Although ceramic transmissive window in the UV-Vis region can be as high as 90% transmission, reflection and scattering losses by the optical material can decrease transmission to less than 90% [24,25].

Herein is disclosed a Mesh-Wire Cuvette (MWC) that can be used in applications in aqueous and non-aqueous media and with capabilities to operate at any wavelength range by removing wavelength optical losses adhered to transmissive optical materials. Thus, the MWC is a sample cell that accommodates a sample of aqueous or non-aqueous nature for instrumental quantitative and qualitative analysis. The design of this new type of cuvette is dedicated to UV-Vis spectroscopy and Far UV spectroscopy, however, it can have applications in attenuated total internal reflection systems, polarimetry, and fluorescence spectrometry. In one aspect, the MWC cuvette is a conventional plastic cuvette that is modified with mesh-wire windows for UV-Vis and Far UV radiation transmission. The MWC can also be designed using metals or ceramics. The mesh-wire window eliminates the two-facing optically transparent windows that come between the sample and probing radiation. Removing the said transparent windows and replacing them with air would allow the passage of incident wavelengths and maximize the transmission ratio of radiation intensity. The mesh-wire cuvette MWC allows users in various areas of science greater access to wavelength regions that are difficult to handle with conventional spectrometers.

In the Examples of the present disclosure, it is demonstrated that the Mesh Wire Cuvette can function as a conventional cuvette in aqueous sample analysis. Using aqueous media, the MWC was shown to perform better than glass cuvettes and even outperform quartz cuvettes in sensitivity. The MWC can operate in spectral regions where the function of conventional cuvettes is compromised. With the advantage in providing higher sensitivity and wider spectral bandwidth, the MWC can open the door to qualitative and quantitative analysis in spectral regions that are practically difficult to work with using conventional UV-Vis spectroscopy.

### D. Coated Metals

In one aspect, the present disclosure relates to metal substrates coated with a superhydrophobic coating that includes at least one bilayer coating including, for example, a first layer and a second layer. In a further aspect, one layer comprises a polyelectrolyte and another layer comprises particles of polytetrafluoroethylene (PTFE). In one aspect, the layer including the polyelectrolyte is a first layer and is deposited onto the metal substrate. In a further aspect, the layer including the PTFE particles is a second layer and is deposited onto the polyelectrolyte layer.

In one aspect, the polyelectrolyte of the superhydrophobic coating is a polyamine, a polyethyleneimine (PEI), and combinations thereof. A polyamine can include polyallylamine hydrochloride. The polyelectrolytes can have an average molecular weight of from about 50 kDa to about 1000 kDa.

The bilayer superhydrophobic coating can have an average thickness of from about 0.1 μm to about 10 μm. In one aspect, the first layer has an average thickness of from about 0.1 nm to about 50 nm. In another aspect, the second layer of the coating can be a colloidal layer including particles of PTFE. The particles of PTFE can have an average diameter of from about 0.1 μm to about 10 μm. In a further aspect, the second layer can have a thickness of from about 0.1 μm to about 10 μm.

In another aspect, the superhydrophobic coating includes more than one bilayer coating sequentially layered on one another. In a further aspect, the superhydrophobic coating can include from two bilayer coatings to 20 bilayer coatings. In another aspect, the superhydrophobic coating includes two bilayer coatings. In yet another aspects, the superhydrophobic coating includes three bilayer coatings.

The metal substrate can comprise various forms and substances. In one aspect, the metal substrate can include a solid metal surface. In another aspect, the substrate can include a mesh. The mesh size can be mesh #120, 70, 38, 16, or combinations thereof. Mesh #is the count of the number of openings in one square inch of the substrate. In other aspects, the metal substrate can include aluminum, iron, copper, zinc, silver, gold, tin, and combinations thereof. In a further aspects, the metal substrate can include alloys comprising one or more of aluminum, iron, copper, zinc, silver, gold, and tin. In another aspect, the metal substrate can include bronze, brass, steel, or combinations thereof.

The wettability of a surface, such as a metal substrate, can be characterized using the contact angle measured via the sessile drop method. The contact angle is an angle formed between a liquid and a solid surface when the liquid is in contact with the surface. For a porous surface, such as a mesh, the contact angle may be the Cassie-Baster contact angle. The sessile drop method includes applying a drop of a liquid (such as water) onto a sample surface and measuring the contact angle. In one aspect, the coated metal substrate of the present application has a contact angle of at least about 125° as determined using a sessile drop of water on the superhydrophobic coating of the coated metal. In another aspect, the metal substrate coated with the superhydrophobic coating has a contact angle that is at least about 1.2-fold greater than an identical metal substrate lacking the superhydrophobic coating, where both contact angles are measured using a sessile drop of water.

### E. Making Coated Metals

In another aspect, the present disclosure relates to a method of making a disclosed coated metal. The method of making can include forming a superhydrophobic coating comprising at least a first layer and a second layer, where forming the superhydrophobic coating includes depositing the first layer on a metal substrate and the second layer on the first layer. In a further aspect, the first layer can include a polyelectrolyte and the second layer can include particles of PTFE. Depositing the first layer on a metal substrate can include contacting the metal substrate with a solution of a polyelectrolyte, where the solution of the polyelectrolyte includes from about 1 mM to about 100 mM of the polyelectrolyte and from about 1 mM to about 100 mM of the salt. Depositing the second layer on the first layer can include contacting the metal substrate comprising the first layer with a colloidal solution of the PTFE. In a further aspect, the colloidal solution of the PTFE can include about 1 wt % to about 60 wt % of the PTFE.

In one aspect, the solution of the polyelectrolyte includes the salt. In a further aspect, the solution of the polyelectrolyte includes about 10 mM to about 500 mM of the salt. The salt can be selected from NaHCO₃, Na₂CO₃, NaCl, KCl, CsCl, RbCI, MgCl₂, CaCl₂, KHCO₃, K₂CO₃, and combinations thereof. In another aspect, the solution of the polyelectrolyte includes about 1 mM to about 50 mM of the polyelectrolyte. The solution of the polyelectrolyte can be an aqueous solution. In a further aspect, the solution of the polyelectrolyte can have a pH of about 1 to about 13. In another aspect, the solution of the polyelectrolyte can have a pH of about 7 to about 12.

In one aspect, the colloidal solution of the PTFE includes about 1 wt % to about 50 wt % of the PTFE.

The metal substrate can undergo a pre-treatment prior to contacting the metal substrate with the first layer. In one aspect, the pre-treatment included rinsing with a solvent, treating with an oxidant solution, and plasma etching. The solvent can be selected from methanol, ethanol isopropanol, dichloromethane, tetrahydrofuran, chloroform, and combinations thereof. The oxidant solution can include ammonia and a peroxide. In one aspect, the oxidant solution includes about 1% to about 15% of a peroxide and about 10% to about 50% ammonia. In another aspect, the oxidant solution includes a 1:1 mixture of about 30% peroxide and 28% ammonia. The peroxide can be hydrogen peroxide.

Di-ionized pure water can be used to prepare the polyelectrolyte solutions and to dilute the PTFE colloid. In one aspect, the polyelectrolyte solution includes Polyelectrolyte polyallylamine hydrochloride (PAH) powder from Alfa Aesar (M_{W}˜120K to 200K). The PAH solution used can have a concentration of 20 mM dosed with 0.1M NaCl salt. In a further aspect, the PTFE colloid suspension can include 60 wt % of the PTFE and can be diluted to a 10% colloidal solution with pure water. Instrumental analysis can be carried out using a NICOLET iS50 FTIR spectrometer from Thermo-Fisher Scientific, the Contact Angle Measurements (CAM) Goniometer from Ossila Inc., and the PHENOM scanning electron microscope (SEM) analysis from Nanoscience. Metallic mesh substrates of different mesh sizes can be obtained from McMaster Carr supplies. A stainless Steel SS304 substrate with mesh #120, 70, 38, and 16 can be used along with an aluminum substrate of mesh #16. Solid plates of SS304 ASTM A240, carbon steel ASTM A216, and aluminum Al-6063 can also be used. All metallic substrates can be rinsed with 95% reagent alcohol, followed by 50/50 peroxide/28% ammonia solution, then plasma etched using a plasma cleaner from Harrick Scientific.

The first and second layers can be deposited using a variety of methods. The metal substrate can be contacted with the first layer, such as a solution of a polyelectrolyte, via spraying, dipping, flowing, or combinations thereof of the first layer onto the metal substrate. Following contacting the metal substrate with the first layer, the metal substrate can be rinsed. The metal substrate comprising the first layer can be contacted with the second layer, such as a colloidal solution of the PTFE, via spraying, dipping, flowing, or combinations thereof of the second layer onto the metal substrate comprising the first layer.

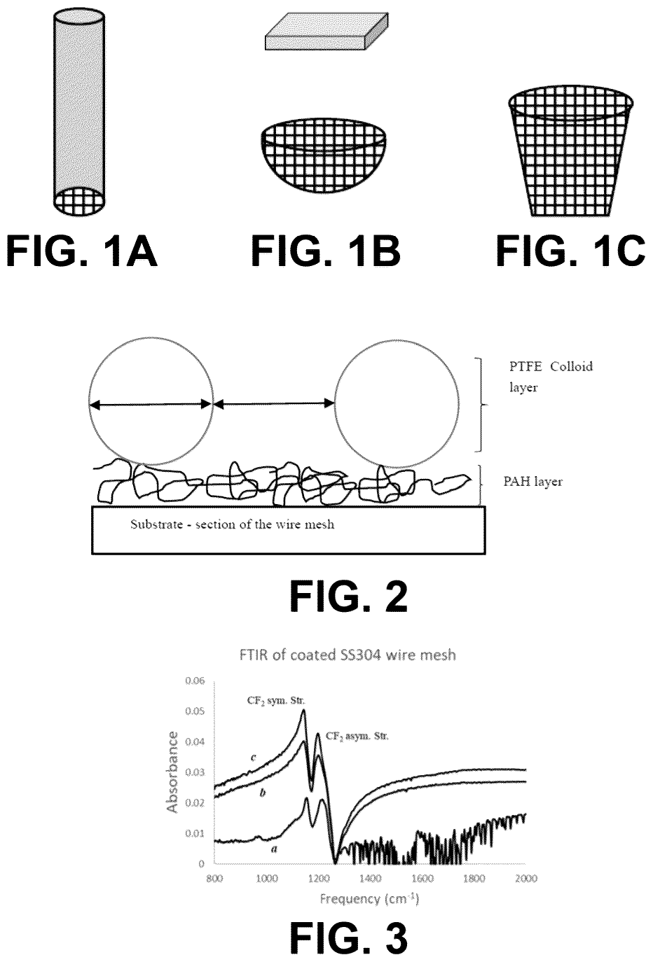

Polyelectrolyte, such as PAH, deposition can work with either wet etching or plasma etching depending on the application. In one example, the mesh substrates can be machined either to fit the end of a glass pipe (GP) of 1.3 cm diameter (FIG. 1A), a round spoon (RS) of 1.5 cm diameter and 0.5-1.0 cm depth (FIG. 1B), or a mini bucket (MB) of 1.2 cm diameter with a 2.0-2.5 cm height (FIG. 1C).

A one-bilayer coating of polyelectrolyte (such as PAH) and PTFE can be applied to all plates and mesh substrates as depicted in FIG. 2. The deposition process can be started by dipping the clean etched substrate in the polyelectrolyte solution for 30 minutes. The one layer of polyelectrolyte is to functionalize the surface followed optionally by three times rinsing in pure water. The rinsed surface can then be dipped in the PTFE colloid solution for 30 minutes followed optionally by three times rinsing in pure water.

After depositing the second layer, the metal substrate can be cured. The curing can include heating the metal substrate comprising the superhydrophobic coating at a temperature of from about 30° C. to about 70° C. for a period of from about 15 minutes to about 12 hours. In another aspect, the curing can include heating the metal substrate comprising the superhydrophobic coating at a temperature of from about 40° C. to about 65° C. for a period of from about 30 minutes to about 12 hours. In one example, the polyelectrolyte is PAH and the PAH/PTFE bilayer coating can be left to cure at a temperature of ˜50 to 60° C. for two hours.

### F. Applications of Coated Metals

In another aspect, the present disclosure relates to articles and products comprising a disclosed coated metal or a coated metal made by a disclosed process, e.g., cuvettes used in spectrometers (e.g., UV-Vis instruments, electrochemical UV-Vis instruments, IR instruments), pumps, plumbing components, liquid-liquid extraction/separation columns, liquid-liquid capacitors for energy storage and detection, metals surfaces of vehicles (e.g., watercraft, automobiles, trucks, aircraft and the like), storage vessels have a metal surface in contact with a liquid, and the like.

The present disclosure also relates to other products, such as an apparatus comprising a metal mesh coated with a superhydrophobic or superamphiphobic coating. This apparatus will be described with reference to FIGS. 23A-23C. The apparatus 100 comprises a base 103; a first wall 106, wherein the first wall 106 extends perpendicularly from the base 103; a second wall 109, wherein the second wall 109 extends perpendicularly from the base 103 and is parallel with the first wall 106; a third wall 113, wherein the third wall 113 extends perpendicularly from the base 103 and extends between the first wall 106 and the second wall 109; and a fourth wall 116, wherein the fourth wall 116 extends perpendicularly from the base 103, extends between the first wall 106 and the second wall 109, and is parallel to the third wall 113; wherein, a portion of the first wall 106 comprises a first opening 119 covered by a first mesh wire 126; a portion of the second wall 109 comprises a second opening 123 covered by a second mesh wire 129, wherein the first opening 119 is aligned with the second opening 123; wherein the first mesh wire 126 comprises a superhydrophobic or superamphiphobic coating; and wherein the second mesh wire 129 comprises a superhydrophobic or superamphiphobic coating. In one aspect, apparatus 100 is configured to hold a sample solution. In a further aspect, apparatus 100 is a cuvette or optical sample cell.

The dimensions of apparatus 100 can vary. In one aspect, apparatus 100 is a cuvette, optical sample cell, or the like configured for use in spectrophotometers, luminometers, fluorometers, and the like. The cuvette or related apparatus can have a path length of about 1 mm to about 100 mm. Path length can be defined as the distance light travels as it passes through the walls of a cuvette or related apparatus. A cuvette or related apparatus can also be measured by an inner length, inner width, and inner height. In one aspect, the inner length and inner width are the length and width of the base of apparatus 100 and/or the length of the walls (106, 109, 113, and 116) of apparatus 100. In another aspect, the inner height is the height of the walls (106, 109, 113, and 116) of apparatus 100. In one aspect, the inner length of the cuvette or related apparatus can be from about 1 mm to about 100 mm, about 1 mm to about 50 mm, about 1 mm to about 25 mm, or about 1 mm to about 15 mm. In another aspect, the inner width of the cuvette or related apparatus can be from about 1 mm to about 100 mm, about 1 mm to about 50 mm, about 1 mm to about 25 mm, or about 1 mm to about 15 mm. In one aspect, the inner length and inner width have approximately the same value. In another aspect, the inner height of the cuvette or related apparatus can be greater than 10 mm. In a further aspect, the inner height of the cuvette or related apparatus can be from about 10 mm to about 200 mm, about 10 mm to about 150 mm, about 10 mm to about 100 mm, or about 10 mm to about 50 mm. In one aspect, the thickness or width of the walls (106, 109, 113, and 116) of apparatus 100 can range from about 0.5 mm to about 5 mm, about 0.5 mm to about 2.5 mm, about 0.5 mm to about 2.0 mm, or about 1.0 mm to about 2.0 mm. In one aspect, the thickness or height of base 103 can range from about 0.5 mm to about 5 mm, about 0.5 mm to about 2.5 mm, about 0.5 mm to about 2.0 mm, or about 1.0 mm to about 2.0 mm. In one aspect, the thickness of base 103 is the same as the thickness of walls 106, 109, 113, and 116.

The dimensions and location of the openings 119 and 123 of apparatus 100 can also vary. The location of openings 119 and 123 on their respective walls of apparatus 100 can be measured by a Z dimension or Z height, which corresponds to the distance from the bottom of base 103 to the center of the opening (119 or 123). The Z height of openings 119 and 123 can vary depending on the height or inner height of apparatus 100. In one aspect, the Z height of openings 119 and 123 is from about 5 mm to about 50 mm, about 5 mm to about 40 mm, about 5 mm to about 30 mm, about 5 mm to about 20 mm, or about 8 mm to about 20 mm. In another aspect, the Z height of openings 119 and 123 is about ½, about ⅓, about ¼, about ⅕, about ⅙, about 1/7, about ⅛, about 1/9, about 1/10, about 1/11, or about 1/12 of the inner height of the wall of the apparatus the opening is in. In a further aspect, the Z height of openings 119 and 123 is the same. The length and width of openings 119 and 123 can be the same or different. In one aspect, the length of the openings can range from about 0.1 mm to about 100 mm, about 0.1 mm to about 50 mm, about 0.1 mm to about 25 mm, about 0.1 mm to about 15 mm or about 0.1 mm to about 10 mm. In another aspect, the width of the openings can range from about 0.1 mm to about 100 mm, about 0.1 mm to about 50 mm, about 0.1 mm to about 25 mm, about 0.1 mm to about 15 mm or about 0.1 mm to about 10 mm. In a further aspect, the length of openings 119 and 123 are the same and the width of openings 119 and 123 are the same.

The base 103 and walls (106, 109, 113, and 116) of apparatus 100 can be comprised of the same or different materials. Such materials can include plastic (e.g., polystyrene and polymethyl methacrylate), glass (e.g., optical and borosilicate), quartz (e.g., optical grade), and ceramic. Plastic can include polystyrene and polymethyl methacrylate. In another aspect, the base 103 and walls (106, 109, 113, and 116) of apparatus 100 can be comprised of Al₂O₃, sapphire ceramic.

The type and composition of mesh wires 126 and 129 of apparatus 100 can include the same or different materials. In one aspect, the mesh wire is any coated metal disclosed herein. The mesh wire can be a mesh #120, 70, 38, 16, or combinations thereof. In a further aspect, the mesh wire is mesh #38. The mesh wire can be a metal including aluminum, iron, copper, zinc, silver, gold, tin, or combinations of the foregoing. The mesh wire can also comprise one or more alloys of aluminum, iron, copper, zinc, silver, gold, and tin. In a further aspect, the mesh wire includes bronze, brass, steel, or combinations thereof. The coating of the mesh wire can be selected based on the type of sample solution to be held by the apparatus 100. In one aspect, the coating can be a superhydrophobic coating, such as a superhydrophobic coating disclosed herein. In another aspect, the coating can be a superamphiphobic coating. The same coating or different coatings can be used on each of mesh wire 126 and 129.

The type and composition of mesh wires 126 and 129 can be selected for different uses. In one aspect, the mesh # of the mesh wire is selected based on an operating temperature that the apparatus will be used in. For example, when apparatus 100 is to be used in temperatures at about 30° C. or above 30° C., then a smaller mesh opening, corresponding to a larger mesh #, may be selected.

In one aspect, apparatus 100 is a cuvette configured to hold sample solutions for spectroscopic analysis. Cuvettes can be used in spectrophotometers, luminometers, and fluorometers. The type of cuvette selected for spectroscopic measurement depends on a variety of factors, including what chemical is being measured, the absorbance spectra of the cuvette, the type of spectrometer to be used for measurement, and economic concerns, such as cost and reusability. Including mesh wire in a cuvette provides several advantages over traditional plastic, glass, quartz, and ceramic cuvettes. The mesh wire cuvette (MWC) can be manufactured at an economical price using existing, commercially available cuvettes (plastic, glass, quartz, and ceramic cuvettes). Materials to produce the mesh wire and coating can also be widely commercially available. The MWC is transparent to a broader range of wavelengths (e.g., Far UV to X-Ray) than traditional plastic, glass, quartz, or ceramic cuvettes, enabling it to be used in Far UV applications. In one aspect, the MWC allows for the transmission of shorter wavelengths than traditional cuvettes, such as wavelengths that are less than 200 nm, less than 190 nm, or less than 180 nm. In another aspect, MWC allows for the transmission of shorter wavelengths than traditional cuvettes, such as wavelengths that are from about 0.01 nm to about 200 nm, about 0.02 nm to about 190 nm, about 0.03 nm to about 190 nm, or about 0.03 nm to about 180 nm. Additionally, the mesh wire portions of the cuvette can be resistant to scratching, unlike other cuvette surfaces, allowing the MWC to be more efficient at transmitting light. The coated wire mesh system can also be reusable.

The MWC has the advantage of being transparent to any wavelength and can function in any spectral region. In order to be able to function in the Far UV region, conventional UV-Vis spectrometers must be equipped with sources, detectors, and optical components that operate in wavelength regions of 100 nm to 190 nm. In fact, vacuum UV spectrometers possess sources and detectors that operate from 10 nm to 200 nm. For example, Deuterium lamps, Hydrogen lamps, and Hollow Cathode lamps act as suitable Far UV sources [26,27,28]. For detection, photodiodes and photomultipliers with specialty coating can serve as good detectors. Diamond films were used as suitable detectors [26,27,28]. The humidity-sensitive optical windows can be isolated from water molecules that can get airborne from the MWC. In one aspect, optical windows are coated with nano-thin materials to minimize their degradation by humidity or air impurities [27].

In one aspect, the Mesh Wire Cuvette can include a plastic cuvette modified to have two openings that are covered by a 38-mesh wire (1 mm×0.5 mm holes), FIG. 10A. The mesh wire can be coated by a polyallylamine hydrochloride/Polytetrafluorethylene ultrathin

film to make it acquire a superhydrophobic surface. A scanning electron micrograph, FIG. 10B, shows the coated and uncoated surface where UV-Vis radiation can pass through the grid. Pouring a solution inside the cuvette gets trapped by the mesh wire ready to be probed by UV-Vis radiation. The cuvette can be designed to fit inside a Thermo Scientific Evolution 220 UV-Vis spectrometer set at wavelength range 1100 nm-190 nm, 100% T for empty holder or solvent correction, 1 nm resolution.

### G. Aspects

The following listing of exemplary aspects supports and is supported by the disclosure provided herein.

Aspect 1. A coated metal comprising a metal substrate; and a superhydrophobic coating comprising a bilayer coating comprising a first layer and a second layer; wherein the first layer comprises a polyelectrolyte; wherein the second layer comprises particles of polytetrafluoroethylene; wherein the first layer is deposited on the metal substrate; and wherein the second layer is deposited on the first layer.

Aspect 2. The coated metal of aspect 1, wherein the metal substrate comprises a solid surface.

Aspect 3. The coated metal of aspect 1, wherein the metal substrate comprises a mesh.

Aspect 4. The coated metal of aspect 3, wherein the mesh is a mesh #120, 70, 38, 16, or combinations thereof.

Aspect 5. The coated metal of any one of aspects 1-4, wherein the metal substrate comprises aluminum, iron, copper, zinc, silver, gold, tin, combinations of the foregoing, and/or alloys comprising one or more of the foregoing.

Aspect 6. The coated metal of any one of aspects 1-3, wherein the metal substrate comprises bronze, brass, steel, or combinations thereof.

Aspect 7. The coated metal of any one of aspects 1-6, wherein the polyelectrolyte is selected from polyamine, polyethyleneimine (PEI), and combinations thereof.

Aspect 8. The coated metal of aspect 7, wherein the polyelectrolyte comprises polyamine.

Aspect 9. The coated metal of aspect 8, wherein the polyamine comprises polyallylamine hydrochloride.

Aspect 10. The coated metal of aspect 9, wherein the polyallylamine hydrochloride has an average molecular weight of from about 50 kDa to about 1000 kDa.

Aspect 11. The coated metal of aspect 9, wherein the polyallylamine hydrochloride has an average molecular weight of from about 100 kDa to about 300 kDa.

Aspect 12. The coated metal of aspect 9, wherein the polyallylamine hydrochloride has an average molecular weight of from about 120 kDa to about 200 kDa.

Aspect 13. The coated metal of aspect 7, wherein polyelectrolyte comprises polyethyleneimine.

Aspect 14. The coated metal of aspect 13, wherein the polyethyleneimine has an average molecular weight of from about 50 kDa to about 1000 kDa.

Aspect 15. The coated metal of aspect 13, wherein the polyethyleneimine has an average molecular weight of from about 100 kDa to about 300 kDa.

Aspect 16. The coated metal of aspect 13, wherein the polyethyleneimine has an average molecular weight of from about 120 kDa to about 200 kDa.

Aspect 17. The coated metal of any one of aspects 1-16, wherein the bilayer coating has an average thickness of from about 0.1 μm to about 10 μm.

Aspect 18. The coated metal of aspect 17, wherein the bilayer coating has an average thickness of from about 0.1 μm to about 7.5 μm.

Aspect 19. The coated metal of aspect 17, wherein the bilayer coating has an average thickness of from about 0.1 μm to about 5 μm.

Aspect 20. The coated metal of aspect 17, wherein the bilayer coating has an average thickness of from about 0.2 μm to about 5 μm.

Aspect 21. The coated metal of aspect 17, wherein the bilayer coating has an average thickness of from about 0.3 μm to about 5 μm.

Aspect 22. The coated metal of aspect 17, wherein the bilayer coating has an average thickness of from about 0.4 μm to about 5 μm.

Aspect 23. The coated metal of aspect 17, wherein the bilayer coating has an average thickness of from about 0.5 μm to about 5 μm.

Aspect 24. The coated metal of aspect 17, wherein the bilayer coating has an average thickness of from about 0.5 μm to about 4 μm.

Aspect 25. The coated metal of aspect 17, wherein the bilayer coating has an average thickness of from about 0.5 μm to about 3 μm.

Aspect 26. The coated metal of aspect 17, wherein the bilayer coating has an average thickness of from about 0.5 μm to about 2.5 μm.

Aspect 27. The coated metal of aspect 17, wherein the bilayer coating has an average thickness of from about 0.5 μm to about 2 μm.

Aspect 28. The coated metal of aspect 17, wherein the bilayer coating has an average thickness of from about 0.5 μm to about 1.5 μm.

Aspect 29. The coated metal of aspect 17, wherein the bilayer coating has an average thickness of from about 0.5 μm to about 1 μm.

Aspect 30. The coated metal of any one of aspects 1-29, wherein the second layer is a colloidal layer comprising particles of polytetrafluoroethylene.

Aspect 31. The coated metal of aspect 30, wherein the particles of polytetrafluoroethylene have an average diameter of from about 0.1 μm to about 10 μm.

Aspect 32. The coated metal of aspect 30, wherein the particles of polytetrafluoroethylene have an average diameter of from about 0.1 μm to about 5 μm.

Aspect 33. The coated metal of aspect 30, wherein the particles of polytetrafluoroethylene have an average diameter of from about 0.1 μm to about 4 μm.

Aspect 34. The coated metal of aspect 30, wherein the particles of polytetrafluoroethylene have an average diameter of from about 0.1 μm to about 3 μm.

Aspect 35. The coated metal of aspect 30, wherein the particles of polytetrafluoroethylene have an average diameter of from about 0.1 μm to about 2 μm.

Aspect 36. The coated metal of aspect 30, wherein the particles of polytetrafluoroethylene have an average diameter of from about 0.1 μm to about 1 μm.

Aspect 37. The coated metal of aspect 30, wherein the particles of polytetrafluoroethylene have an average diameter of from about 0.5 μm to about 10 μm.

Aspect 38. The coated metal of aspect 30, wherein the particles of polytetrafluoroethylene have an average diameter of from about 0.5 μm to about 5 μm.

Aspect 39. The coated metal of aspect 30, wherein the particles of polytetrafluoroethylene have an average diameter of from about 0.5 μm to about 2.5 μm.

Aspect 40. The coated metal of aspect 30, wherein the particles of polytetrafluoroethylene have an average diameter of from about 0.5 μm to about 1.5 μm.

Aspect 41. The coated metal of any one of aspects 1-40, wherein the first layer has an average thickness of from about 0.1 nm to about 50 nm.

Aspect 42. The coated metal of aspect 41, wherein the first layer has an average thickness of from about 1 nm to about 50 nm.

Aspect 43. The coated metal of aspect 41, wherein the first layer has an average thickness of from about 5 nm to about 50 nm.

Aspect 44. The coated metal of aspect 41, wherein the first layer has an average thickness of from about 10 nm to about 50 nm.

Aspect 45. The coated metal of aspect 41, wherein the first layer has an average thickness of from about 1 nm to about 40 nm.

Aspect 46. The coated metal of aspect 41, wherein the first layer has an average thickness of from about 5 nm to about 40 nm.

Aspect 47. The coated metal of aspect 41, wherein the first layer has an average thickness of from about 10 nm to about 40 nm.

Aspect 48. The coated metal of aspect 41, wherein the first layer has an average thickness of from about 1 nm to about 30 nm.

Aspect 49. The coated metal of aspect 41, wherein the first layer has an average thickness of from about 5 nm to about 30 nm.

Aspect 50. The coated metal of aspect 41, wherein the first layer has an average thickness of from about 10 nm to about 30 nm.

Aspect 51. The coated metal of aspect 41, wherein the first layer has an average thickness of from about 1 nm to about 20 nm.

Aspect 52. The coated metal of aspect 41, wherein the first layer has an average thickness of from about 5 nm to about 20 nm.

Aspect 53. The coated metal of aspect 41, wherein the first layer has an average thickness of from about 10 nm to about 20 nm.

Aspect 54. The coated metal of any one of aspects 1-53, wherein the second layer has a thickness of from about 0.1 μm to about 10 μm.

Aspect 55. The coated metal of aspect 54, wherein the second layer has a thickness of from about 0.1 μm to about 5 μm.

Aspect 56. The coated metal of aspect 54, wherein the second layer has a thickness of from about 0.1 μm to about 4 μm.

Aspect 57. The coated metal of aspect 54, wherein the second layer has a thickness of from about 0.1 μm to about 3 μm.

Aspect 58. The coated metal of aspect 54, wherein the second layer has a thickness of from about 0.1 μm to about 2 μm.

Aspect 59. The coated metal of aspect 54, wherein the second layer has a thickness of from about 0.1 μm to about 1 μm.

Aspect 60. The coated metal of aspect 54, wherein the second layer has a thickness of from about 0.5 μm to about 10 μm.

Aspect 61. The coated metal of aspect 54, wherein the second layer has a thickness of from about 0.5 μm to about 5 μm.

Aspect 62. The coated metal of aspect 54, wherein the second layer has a thickness of from about 0.5 μm to about 2.5 μm.

Aspect 63. The coated metal of aspect 54, wherein the second layer has a thickness of from about 0.5 μm to about 2.0 μm.

Aspect 64. The coated metal of aspect 54, wherein the second layer has a thickness of from about 0.5 μm to about 1.5 μm.

Aspect 65. The coated metal of aspect 54, wherein the second layer has a thickness of from about 0.5 μm to about 1.0 μm.

Aspect 66. The coated metal of any one of aspects 1-65, wherein coated metal has a contact angle of at least about 125° when determined using a sessile drop of water on the superhydrophobic coating of the coated metal.

Aspect 67. The coated metal of aspect 66, wherein coated metal has a contact angle of at least about 130°.

Aspect 68. The coated metal of aspect 66, wherein coated metal has a contact angle of at least about 140°.

Aspect 69. The coated metal of aspect 66, wherein coated metal has a contact angle of at least about 150°.

Aspect 70. The coated metal of aspect 66, wherein coated metal has a contact angle of at least about 160°.

Aspect 71. The coated metal of any one of aspects 1-40, wherein coated metal has a contact angle determined using a sessile drop of water on the superhydrophobic coating of the coated metal that is at least about 1.2-fold greater than a contact angle determined using a sessile drop of water placed on an identical metal substrate as the coated metal but lacking the superhydrophobic coating.

Aspect 72. The coated metal of aspect 71, wherein the contact angle of the coated metal is at least about 1.3-fold greater than the contact angle determined on an identical metal substrate as the coated metal but lacking the superhydrophobic coating.

Aspect 73. The coated metal of aspect 71, wherein the contact angle of the coated metal is at least about 1.4-fold greater than the contact angle determined on an identical metal substrate as the coated metal but lacking the superhydrophobic coating.

Aspect 74. The coated metal of aspect 71, wherein the contact angle of the coated metal is at least about 1.5-fold greater than the contact angle determined on an identical metal substrate as the coated metal but lacking the superhydrophobic coating.

Aspect 75. The coated metal of aspect 71, wherein the contact angle of the coated metal is at least about 1.6-fold greater than the contact angle determined on an identical metal substrate as the coated metal but lacking the superhydrophobic coating.

Aspect 76. The coated metal of aspect 71, wherein the contact angle of the coated metal is at least about 1.7-fold greater than the contact angle determined on an identical metal substrate as the coated metal but lacking the superhydrophobic coating.

Aspect 77. The coated metal of aspect 71, wherein the contact angle of the coated metal is at least about 1.8-fold greater than the contact angle determined on an identical metal substrate as the coated metal but lacking the superhydrophobic coating.

Aspect 78. The coated metal of aspect 71, wherein the contact angle of the coated metal is at least about 1.9-fold greater than the contact angle determined on an identical metal substrate as the coated metal but lacking the superhydrophobic coating.

Aspect 79. The coated metal of aspect 71, wherein the contact angle of the coated metal is at least about 2-fold greater than the contact angle determined on an identical metal substrate as the coated metal but lacking the superhydrophobic coating.

Aspect 80. The coated metal of aspect 71, wherein the contact angle of the coated metal is at least about 2.5-fold greater than the contact angle determined on an identical metal substrate as the coated metal but lacking the superhydrophobic coating.

Aspect 81. The coated metal of any one of aspects 1-80, wherein the superhydrophobic coating comprises more than one bilayer coating sequentially layered on one another.

Aspect 82. The coated metal of aspect 81, wherein the superhydrophobic coating comprises from two bilayer coatings to 20 bilayer coatings.

Aspect 83. The coated metal of aspect 81, wherein the superhydrophobic coating comprises from two bilayer coatings to ten bilayer coatings.

Aspect 84. The coated metal of aspect 81, wherein the superhydrophobic coating comprises from two bilayer coatings to fiver bilayer coatings.

Aspect 85. The coated metal of aspect 81, wherein the superhydrophobic coating comprises from two bilayer coatings.

Aspect 86. The coated metal of aspect 81, wherein the superhydrophobic coating comprises from three bilayer coatings.

Aspect 87. A method of making the coated metal of any one of aspects 1-86, the method comprising the steps of forming superhydrophobic coating comprising a first layer and a second layer; wherein the forming the superhydrophobic coating comprises depositing the first layer on the metal substrate; wherein the forming the superhydrophobic coating comprises depositing the second layer on the first layer; wherein the first layer comprises a polyelectrolyte; wherein the second layer comprises particles of polytetrafluoroethylene; wherein the depositing the first layer on the metal substrate comprises contacting the metal substrate with a solution of the polyelectrolyte comprising from about 1 mM to about 100 mM in the polyelectrolyte; and from about 1 mM to about 1000 mM salt; wherein the depositing the second layer on the first layer comprises contacting the metal substrate comprising the first layer with a colloidal solution of the polytetrafluoroethylene; and wherein the colloidal solution of the polytetrafluoroethylene comprises about 1 wt % to about 60 wt % of the polytetrafluoroethylene.

Aspect 88. The method of aspect 88, wherein the solution of the polyelectrolyte comprises the salt; and wherein the salt is selected from NaHCO3, Na2CO3, NaCl, KCl, CsCl, RbCI, MgCl2, CaCl2, KHCO₃, K2CO3, and combinations thereof.

Aspect 89. The method of aspect 87 or aspect 88, wherein solution of the polyelectrolyte comprises about 10 mM to about 500 mM of the salt.

Aspect 90. The method of aspect 89, wherein solution of the polyelectrolyte comprises about 50 mM to about 400 mM of the salt.

Aspect 91. The method of aspect 89, wherein solution of the polyelectrolyte comprises about 50 mM to about 300 mM of the salt.

Aspect 92. The method of aspect 89, wherein solution of the polyelectrolyte comprises about 50 mM to about 200 mM of the salt.

Aspect 93. The method of aspect 89, wherein solution of the polyelectrolyte comprises about 50 mM to about 150 mM of the salt.

Aspect 94. The method of any one of aspects 87-93, wherein solution of the polyelectrolyte comprises about 1 mM to about 50 mM of the polyelectrolyte.

Aspect 95. The method of aspect 94, wherein solution of the polyelectrolyte comprises about 1 mM to about 40 mM of the polyelectrolyte.

Aspect 96. The method of aspect 94, wherein solution of the polyelectrolyte comprises about 1 mM to about 30 mM of the polyelectrolyte.

Aspect 97. The method of aspect 94, wherein solution of the polyelectrolyte comprises about 1 mM to about 25 mM of the polyelectrolyte.

Aspect 98. The method of aspect 94, wherein solution of the polyelectrolyte comprises about 1 mM to about 20 mM of the polyelectrolyte.

Aspect 99. The method of aspect 94, wherein solution of the polyelectrolyte comprises about 5 mM to about 40 mM of the polyelectrolyte.

Aspect 100. The method of aspect 94, wherein solution of the polyelectrolyte comprises about 5 mM to about 30 mM of the polyelectrolyte.

Aspect 101. The method of aspect 94, wherein solution of the polyelectrolyte comprises about 5 mM to about 25 mM of the polyelectrolyte.

Aspect 102. The method of aspect 94, wherein solution of the polyelectrolyte comprises about 5 mM to about 20 mM of the polyelectrolyte.

Aspect 103. The method of aspect 94, wherein solution of the polyelectrolyte comprises about 10 mM to about 40 mM of the polyelectrolyte.

Aspect 104. The method of aspect 94, wherein solution of the polyelectrolyte comprises about 10 mM to about 30 mM of the polyelectrolyte.

Aspect 105. The method of aspect 94, wherein solution of the polyelectrolyte comprises about 10 mM to about 25 mM of the polyelectrolyte.

Aspect 106. The method of aspect 94, wherein solution of the polyelectrolyte comprises about 10 mM to about 20 mM of the polyelectrolyte.

Aspect 107. The method of any one of aspects 87-106, wherein solution of the polyelectrolyte is an aqueous solution.

Aspect 108. The method of any one of aspects 87-107, wherein the colloidal solution of the polytetrafluoroethylene comprises about 1 wt % to about 50 wt % of the polytetrafluoroethylene.

Aspect 109. The method of aspect 108, wherein the colloidal solution of the polytetrafluoroethylene comprises about 1 wt % to about 40 wt % of the polytetrafluoroethylene.

Aspect 110. The method of aspect 108, wherein the colloidal solution of the polytetrafluoroethylene comprises about 1 wt % to about 30 wt % of the polytetrafluoroethylene.

Aspect 111. The method of aspect 108, wherein the colloidal solution of the polytetrafluoroethylene comprises about 1 wt % to about 20 wt % of the polytetrafluoroethylene.

Aspect 112. The method of aspect 108, wherein the colloidal solution of the polytetrafluoroethylene comprises about 1 wt % to about 15 wt % of the polytetrafluoroethylene.

Aspect 113. The method of aspect 108, wherein the colloidal solution of the polytetrafluoroethylene comprises about 1 wt % to about 10 wt % of the polytetrafluoroethylene.

Aspect 114. The method of aspect 108, wherein the colloidal solution of the polytetrafluoroethylene comprises about 5 wt % to about 40 wt % of the polytetrafluoroethylene.

Aspect 115. The method of aspect 108, wherein the colloidal solution of the polytetrafluoroethylene comprises about 5 wt % to about 30 wt % of the polytetrafluoroethylene.

Aspect 116. The method of aspect 108, wherein the colloidal solution of the polytetrafluoroethylene comprises about 5 wt % to about 20 wt % of the polytetrafluoroethylene.

Aspect 117. The method of aspect 108, wherein the colloidal solution of the polytetrafluoroethylene comprises about 5 wt % to about 15 wt % of the polytetrafluoroethylene.

Aspect 118. The method of aspect 108, wherein the colloidal solution of the polytetrafluoroethylene comprises about 5 wt % to about 10 wt % of the polytetrafluoroethylene.

Aspect 119. The method of any one of aspects 87-118, wherein the contacting the metal substrate with the solution of the polyelectrolyte comprises spraying, dipping, flowing, or combinations thereof the solution of the polyelectrolyte onto the metal substrate.

Aspect 120. The method of any one of aspects 87-119, wherein following the contacting the metal substrate with the solution of the polyelectrolyte, the metal substrate comprising the first layer is rinsed.

Aspect 121. The method of aspect 120, wherein the metal substrate comprising the first layer is rinsed with water.

Aspect 122. The method of any one of aspects 87-119, wherein prior to the contacting the metal substrate with the solution of the polyelectrolyte, the metal substrate is pre-treated as follows rinsed with a solvent; treated with an oxidant solution; and plasma etched.

Aspect 123. The method of aspect 122, wherein the solvent is selected from methanol, ethanol isopropanol, dichloromethane, tetrahydrofuran, chloroform, and combinations thereof.

Aspect 124. The method of aspect 122 or aspect 123, wherein the oxidant solution comprises ammonia and a peroxide.

Aspect 125. The method of aspect 124, wherein the oxidant solution comprises about 1% to about 15% of a peroxide; and wherein the oxidant solution comprises about about 10% ammonia to about 50% ammonia.

Aspect 126. The method of aspect 124, wherein the oxidant solution comprises a 11 mixture of about 30% peroxide and 28% ammonia.

Aspect 127. The method of aspect 124, wherein the peroxide is hydrogen peroxide.

Aspect 128. The method of any one of aspects 87-127, wherein the pH of the solution of the polyelectrolyte is from about 1 to about 13.

Aspect 129. The method of aspect 128, wherein the pH of the solution of the polyelectrolyte is from about 7 to about 12.

Aspect 130. The method of aspect 128, wherein the pH of the solution of the polyelectrolyte is from about 8 to about 12.

Aspect 131. The method of aspect 128, wherein the pH of the solution of the polyelectrolyte is from about 9 to about 12.

Aspect 132. The method of aspect 128, wherein the pH of the solution of the polyelectrolyte is from about 10 to about 12.

Aspect 133. The method of any one of aspects 87-118, wherein the contacting the metal substrate comprising the first layer with a colloidal solution of the polytetrafluoroethylene comprises spraying, dipping, flowing, or combinations thereof the colloidal solution of the polytetrafluoroethylene onto the metal substrate comprising the first layer.

Aspect 134. The method of any one of aspects 87-133, further comprising curing the metal substrate comprising the superhydrophobic coating following the contacting the metal substrate comprising the first layer with a colloidal solution of the polytetrafluoroethylene; and wherein the curing comprises heating the metal substrate comprising the superhydrophobic coating at a temperature of from about 30° C. to about 70° C. for a period of from about 15 minutes to about 12 hours.

Aspect 135. The method of aspect 134, wherein the curing comprises heating the metal substrate comprising the superhydrophobic coating at a temperature of from about 40° C.to about 65° C. for a period of from about 30 minutes to about 12 hours.

Aspect 136. The method of aspect 134, wherein the curing comprises heating the metal substrate comprising the superhydrophobic coating at a temperature of from about 50° C.to about 65° C. for a period of from about 30 minutes to about 12 hours.

Aspect 137. The method of aspect 134, wherein the curing comprises heating the metal substrate comprising the superhydrophobic coating at a temperature of from about 50° C. to about 65° C. for a period of from about 30 minutes to about 2 hours.

Aspect 138. A product comprising the coated metal of any one of aspects 1-86 or a coated metal prepared by the method of any one of aspects 87-137.

Aspect 139. The product of aspect 128, wherein the product is a cuvette.

Aspect 140. An apparatus, comprising: a base; a first wall, wherein the first wall extends perpendicularly from the base; a second wall, wherein the second wall extends perpendicularly from the base and is parallel with the first wall; a third wall, wherein the third wall extends perpendicularly from the base and extends between the first wall and the second wall; and a fourth wall, wherein the fourth wall extends perpendicularly from the base, extends between the first wall and the second wall, and is parallel to the third wall; wherein, a portion of the first wall comprises a first opening covered by a first mesh wire; a portion of the second wall comprises a second opening covered by a second mesh wire, wherein the first opening is aligned with the second opening; wherein the first mesh wire comprises a superhydrophobic or superamphiphobic coating; and wherein the second mesh wire comprises a superhydrophobic or superamphiphobic coating.

Aspect 141. The apparatus of aspect 140, wherein the first mesh wire is a mesh #120, 70, 38, 16, or combinations thereof.

Aspect 142. The apparatus of aspect 140 or 141, wherein the second mesh wire is a mesh #120, 70, 38, 16, or combinations thereof.

Aspect 143. The apparatus of any one of aspects 140-142, wherein the first mesh wire and the second mesh wire are a mesh #38.

Aspect 144. The apparatus of any one of aspects 140-143, wherein the first mesh wire comprises aluminum, iron, copper, zinc, silver, gold, tin, combinations of the foregoing, and/or alloys comprising one or more of the foregoing.

Aspect 145. The apparatus of any one of aspects 140-144, wherein the second mesh wire comprises aluminum, iron, copper, zinc, silver, gold, tin, combinations of the foregoing, and/or alloys comprising one or more of the foregoing.

Aspect 146. The apparatus of any one of aspects 140-145, wherein the first mesh wire comprises the coated metal of any one of aspects 1-86 or a coated metal prepared by any one of aspects 87-137.

Aspect 147. The apparatus of any one of aspects 140-145, wherein the second mesh wire comprises the coated metal of any one of aspects 1-86 or a coated metal prepared by any one of aspects 87-137.

Aspect 148. The apparatus of any one of aspects 140-147, wherein the first mesh wire and the second mesh wire are the same.

Aspect 149. The apparatus of any one of aspects 140-148, wherein the base, the first wall, the second wall, the third wall, and the fourth wall comprise a plastic, glass, quartz, ceramic, or a combination thereof.

Aspect 150. The apparatus of aspect 149, wherein the plastic comprises polystyrene or polymethyl methacrylate.

Aspect 151. The apparatus of any one of aspects 140-150, wherein the apparatus is a cuvette.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### H. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Ultrathin Film of Polyallylamine/Polytetrafluoroethylene Colloid Coating on Metallic Substrates

### Results and Discussion

Surface analysis on the coated and uncoated metallic plates and mesh substrates was made using Fourier Transform Infrared FTIR, Scanning Electron Microscopy SEM, and Contact Angle Measurements CAM. The surface analysis was done after curing the coated substrates. The analysis was done using pure water, the using various concentrations of sodium chloride solutions (0.001M to 0.7M with 0.02M increments), and using solutions from pH=1 to pH=13 with one pH unit increment. The liquids were poured on the coated mesh substrates of various geometries i.e., the glass pipe (GP), the round spoon (RS), and the mini bucket (MB) structures to check on their ability to retain pure water, salt solutions, and acid/base solutions of pH range from 1 to 13 imposed by the superhydrophobic effect. The plates (uncoated/coated) were analyzed using CAM and SEM. The mesh wire substrates (uncoated/coated) were analyzed using FTIR, CAM, and SEM.

FTIR Analysis: In FIG. 3, the FTIR spectrum of the coated SS304 120 mesh substrate shows the two-strong characteristic peaks of the C-F stretch bands at 1150 cm⁻¹ and

1200 cm⁻¹ that relate to the deposited per-fluorinated PTFE colloid micro-particles [13]. Multiple depositions of two and three bilayers were attempting, without curing between layers. Note, at both frequency bands, higher peaks were recorded indicating more deposition of PTFE colloid particles as the number of bilayers increased. The strong trough after the C-F stretch band at 1200 cm⁻¹ is not a derivative peak that can be corrected by the Kramers-Kronig algorithm. It might be a diffractive enhancement of the IR beam going through the coated mesh apertures as more layers get deposited.

The IR spectrum of a wire mesh dipped in PTFE colloid only (i.e., no PAH used) then left to dry on a hot plate yielded a similar spectrum to the 2 or 3 bilayers coating. The only difference, the C-F stretch bands of the thermally deposited PTFE colloid appeared at higher frequencies of 1155 cm⁻¹ (cf 1150 cm⁻¹) and 1208 (cf 1200 cm⁻¹), that is, a frequency shift of 5 to 8 cm⁻¹. The shift in the two peaks of the C-F stretch of the PAH/PTFE coating can be attributed to the long-range hydrogen bond interaction between the C-F bond in PTFE and the N—H bond in PAH [14].

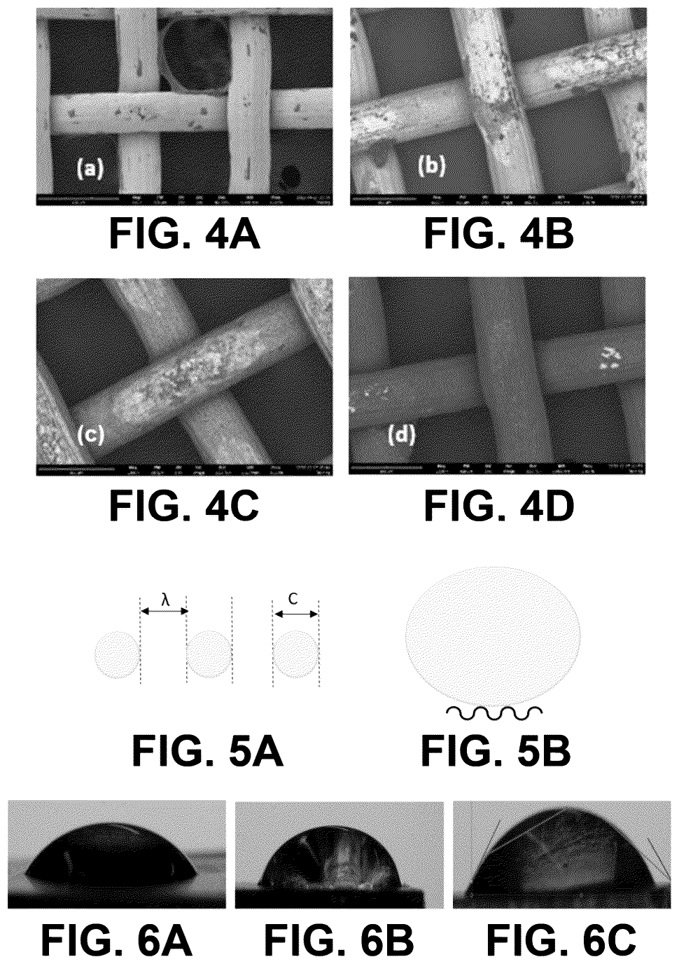

SEM Analysis: In FIG. 4, the SEM image of the uncoated SS304 wire mesh, FIG. 4A, and the coated wire mesh substrate starting with one bilayer FIG. 4B, two bilayers FIG. 4C, then three bilayers FIG. 4D are taken at a magnification range from 900× to 1400×. The white grid-like structure represents the uncoated SS304 which is conducting with a high Z value to reflect the BSE, while the dark-grey granulated films are those of the nonconducting low Z PTFE colloid coating allowing greater penetration depth of BSE. Note the intensity of the grey PTFE deposition increases with more bilayers deposited. The three bilayers show that the metal surface is nearly covered by the PAH-PTFE coating. The wire mesh adhered to an aluminum stub using graphite paste tape.

For this study, no attempt was made to deposit beyond three bilayers because the objective is to transform the hydrophilic metal surface to a superhydrophobic surface with little emphasis on the contribution of film thickness that ranged from 0.5 to 1.0 μm thickness for a three-bilayer coating. SEM reveals that a superhydrophobic surface does not necessarily require a uniform hydrophobic coating, but the pinning of scattered hydrophobic patches that is enhanced by the grid-like structure of the wire mesh substrates. SEM images taken at higher magnification of 19000 and 55000 shows the PAH-PTFE film is a porous structure with cavities <0.5 μm. A porous hydrophobic surface is a condition required to obtain a superhydrophobic effect per the Cassie-Baxter theory [15].

TABLE 2

| Sample | Al | SS304 | SS304 | SS304 | SS304 | SS304 |
|---|---|---|---|---|---|---|
| Liquid | plate | plate | #16 | #38 | #80 | #120 |
| H₂O | 133 | 141 | 146 | 148 | 151 | 160 |
| pH = 13 | 68 | 140 | 129 | 133 | 139 | 156 |
| Salt* | 92 | 143 | 129 | 132 | 140 | 146 |

*A 0.7M salt solution

CAM Analysis: The wire mesh substrate is a wave-like structure, thus another key structural feature that contributes to the superhydrophobic character is the hydrophobic crests of the wavy wire mesh, FIG. 5.

In this regard, a theoretical model that fits a powder-coated substrate is the re-entrant fractal geometry where the Cassie-Baxter contact angle ß of a sessile drop is defined as:

$$cos β = - 1 + ( C / ( C + λ ) ) [ sin θ + ( π - θ ) cos θ ] \qquad ( 1 )$$

The angle θ=105° to 115° is the intrinsic contact angle of a smooth clean PTFE hydrophobic surface (i.e. PTFE plate) [16]. According to equation (1), a higher 0 value indicates a higher Cassie-Baxter contact angle β. For example, a coating of PAH/PTFE on the SS304 plate exhibits adjacent colloidal microparticles with a ratio of C/(C+A)=0.5. When 0=115°, would yield a static contact angle β=141°, which is within the range of experimental values of metallic plates, Table 2. In this study, the geometry of the wire mesh, FIG. 4A, renders C and A nearly equal where the ratio of the aperture size and wire diameter modifies Equation 1 to become Equation 2:

$$cos β = - 1 + ( Ae / 2 We ) [ sin θ + ( π - θ ) cos θ ] \qquad ( 2 )$$

For example, for a wire mesh #120, the effective aperture size Aₑ=1.4×10⁻⁴ m and the effective wire diameter Wₑ=4×10⁻⁵ m, the expected static contact angle β˜158°. The measured static contact angles for a wire mesh #120 ranged from 155 to 160°. Contact angle measurements (CAM) are discussed below using pure water, salt solutions, and pH-controlled solution analysis.

A flat metallic plate that is coated with one bilayer of PAH-PTFE film was examined against a reference uncoated clean metallic plate using the three types of solutions i.e., pure water, dilute salt solutions with concentrations ranging from 0.01M to 0.7M, dilute acidic and basic solutions that ranged in pH from 2 to 13. The pure water used is deionized water with ionic conductivity of 3 to 4 μScm⁻¹.

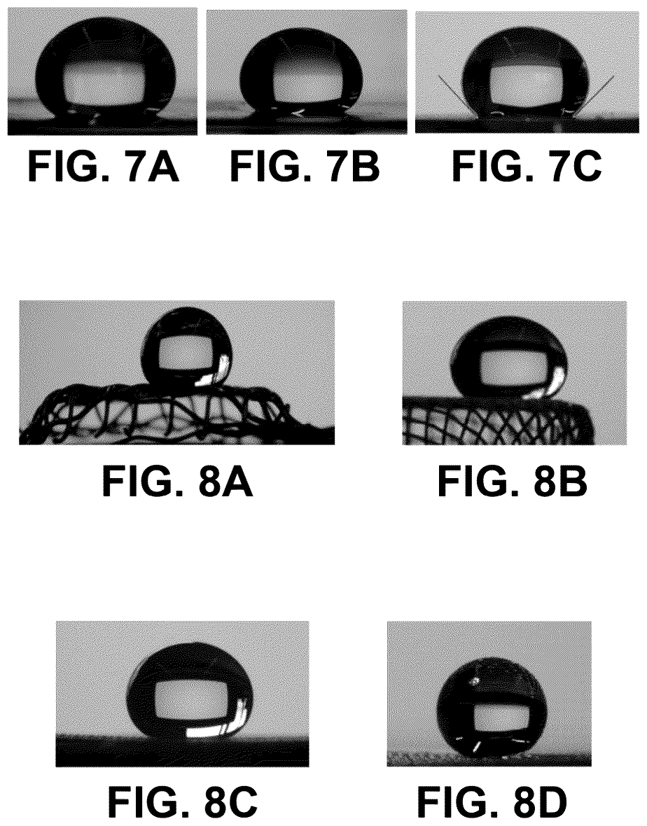

Prior to measuring the static contact angles, the uncoated metallic plates of stainless steel SS304, carbon steel, and aluminum were cleaned with reagent alcohol followed by pure water rinsing. The contact angles measured on the clean metallic surfaces were 65°+4°, 43±4°, and 50°±4° respectively (FIG. 6). When these metallic plates were etch-cleaned with peroxide/ammonia solution or plasma, water perfectly wets the metal surface (i.e., contact angle ˜) 0°. After the deposition of one bilayer of PAH/PTFE/the contact angles changed to 141°±2° for SS304 (FIG. 7B), 146°±2° for carbon steel (FIG. 7A), and 133°±2° for Aluminum (FIG. 7C).

Instead of using aggressive methods to create a porous surface on the metal substrates, metallic mesh substrates were used to attain the superhydrophobic character. A high mesh # such as 120 with a characteristic aperture (or sieve opening) of ˜125 microns is expected to yield the highest contact angle.

For the four SS304 mesh wire geometries i.e., SS304(#16, #38, #70, #120) the contact angles ranged from 146°±4° using SS304 wire mesh 16 (FIG. 8A) to 160°±2° using SS304 wire mesh 120 (FIG. 8D). A higher uncertainty in the measurement of contact angle using the SS304 wire mesh 16 is attributed to a bigger mesh hole and wire thickness. There is a correlation between the mesh number and the contact angle. As the mesh number increases (i.e. smaller aperture) the static contact angle increases indicating a higher superhydrophobic character.

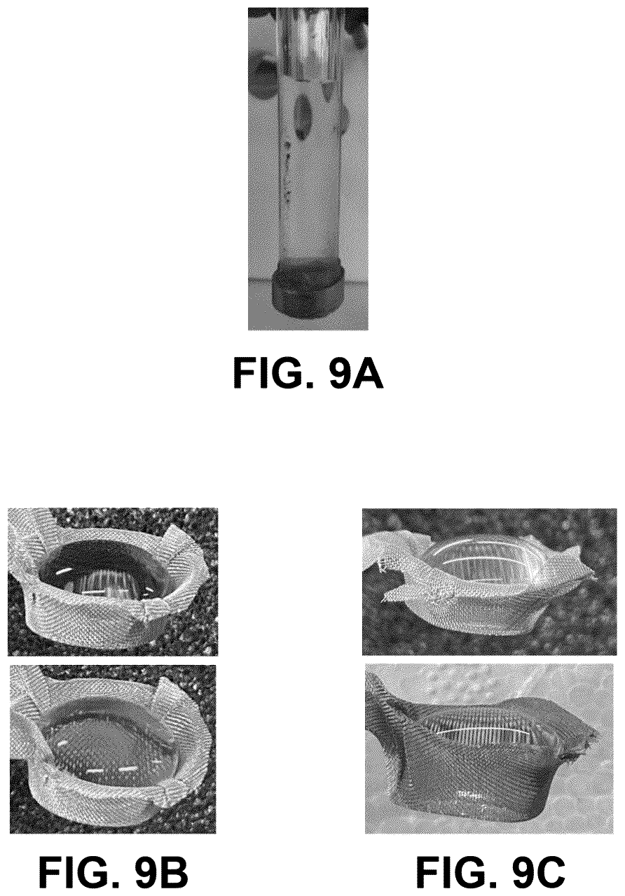

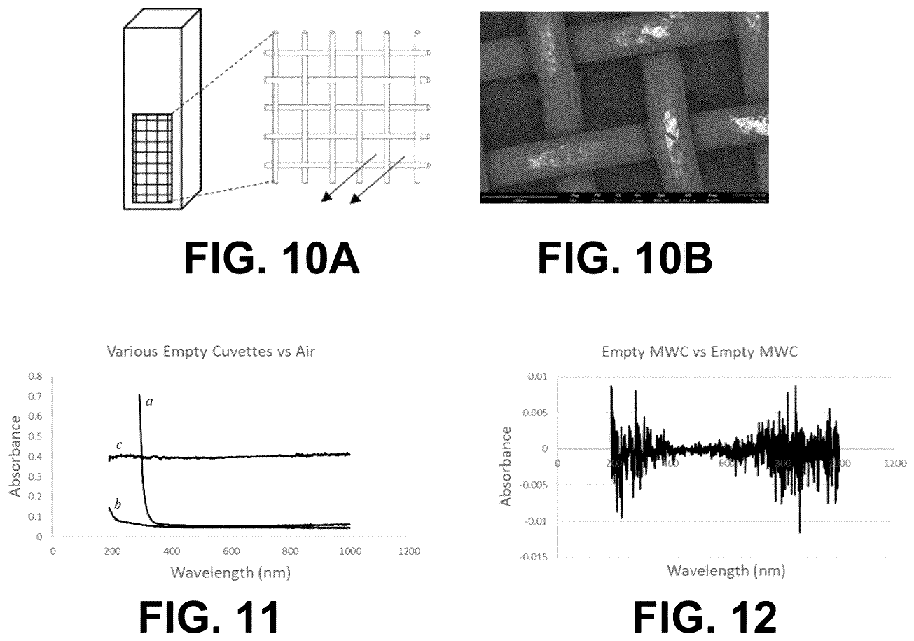

Wₑ have tested the retention of pure water by the various mesh wire buckets by virtue of having superhydrophobic surfaces. For example, a PAH/PTFE coated SS304 wire mesh 120 used to cap a glass pipe GP, FIG. 9A, was able to hold a 5.0 cm column of pure water without leaking.

The mini bucket MB fabricated from a PAH/PTFE coated SS304 wire mesh 120 having a depth of 2.0 cm was able to retain an acid solution of pH=1 or a base solution of pH =13 poured into it, FIG. 9B. The same MB was able of retaining salt solutions from 0.001M to 0.7M, FIG. 9C. Using the spoon structures of a 0.5 cm depth, and 1.5 cm diameter of all mesh types i.e. SS304(#16, #38, #70, #120) and Aluminum (mesh #20) was capable of retaining a 2 mL volume of pure water, solutions of a pH range from 1 to 13 and 0.7 M salt solution. In fact, the PAH/PTFE coating deposited to the mesh wires was tested by incrementing the pH of the acid/base solutions by one pH unit, and for the salt solutions, the NaCl concentration was incremented by 0.02M. Chemical resiliency of the PAH/PTFE coating against concentrated acid/base solutions, salt solutions, and organic solvents shall be conducted in a separate study.

### Example 2: Mesh-Wire Cuvette for Aqueous Sample Analysis in UF-Vis and Far UV Spectroscopy

Herein, we will compare the performance of the mesh wire cuvette (MWC) to the conventional glass cuvette (GC) and the Quartz cuvette (QC) using aqueous solutions of caffeine, hydrochloric acid, and potassium chromate. The cuvette performance was tested in the wavelength region 1100 nm-190 nm using pure water (2.5 to 4 μScm⁻¹), a 200 mg/L Caffeine solution, a 0.0024 M potassium chromate K₂CrO₄ solution, and a 36 mg/L hydrochloric acid solution.

Glass cuvettes and Quartz cuvettes were properly cleaned with ethanol and pure water before use. Mesh-Wire Cuvette MWC was cleaned with pure water only. In this experiment, the three cuvettes were tested against three reference backgrounds. These were i) air (i.e. empty cuvette holder), ii) empty cuvette, and iii) cuvette filled with pure water. Samples were pumped in and out of the same cuvette to maintain a proper ratio to the reference background. To verify a proper background for spectral measurements, water-vs-water spectra were recorded that must show negligible impurity or cross-contamination across sample spectra before any experiments were conducted.

Background Calibration Analysis: The mesh wire and the cuvette opening of the mesh wire cuvette MWC is expected to block a portion of the incident radiation Iₒ. The transmitted radiation through a cuvette I_{c} or the Absorbance was examined by conducting experiments on empty cuvettes against air (i.e. an empty cuvette holder), FIG. 11. The UV-Vis spectrum of the glass cuvette GC gave a spectrum in FIG. 11a with uniform absorbance of 0.05 to 0.1 across a wavelength window of 1000 to 250 nm which starts rising sharply at lower wavelengths because glass blocks UV 190 to 250 nm. The UV-Vis spectrum of the Quartz cuvette QC gave a spectrum in FIG. 11b with uniform absorbance of 0.05 to 0.1 across a wavelength window of 1000 to 250 nm that rises slightly at lower wavelengths because Quartz is transmissive to UV in the 190 to 250 nm region. The UV-Vis spectrum of the MWC gave a spectrum in FIG. 11c with a uniform absorbance of 0.4 across a wavelength window of 1000 to 190 nm pertaining to the blocking of incident UV-Vis radiation by the home-made MWC. Whether or not a 0.4 absorbance compromises sensitivity performance will be addressed in the following paragraphs.

An empty cuvette was tested against an empty cuvette and the expected spectra is a noise background that fluctuates around a zero absorbance. The UV-Vis spectrum of an empty MWC against an empty MWC is shown in FIG. 12 which reflects the expected zero signal with noise spectrum due to the subtraction of the background signal from the sample signal done by the UV-Vis spectrometer.

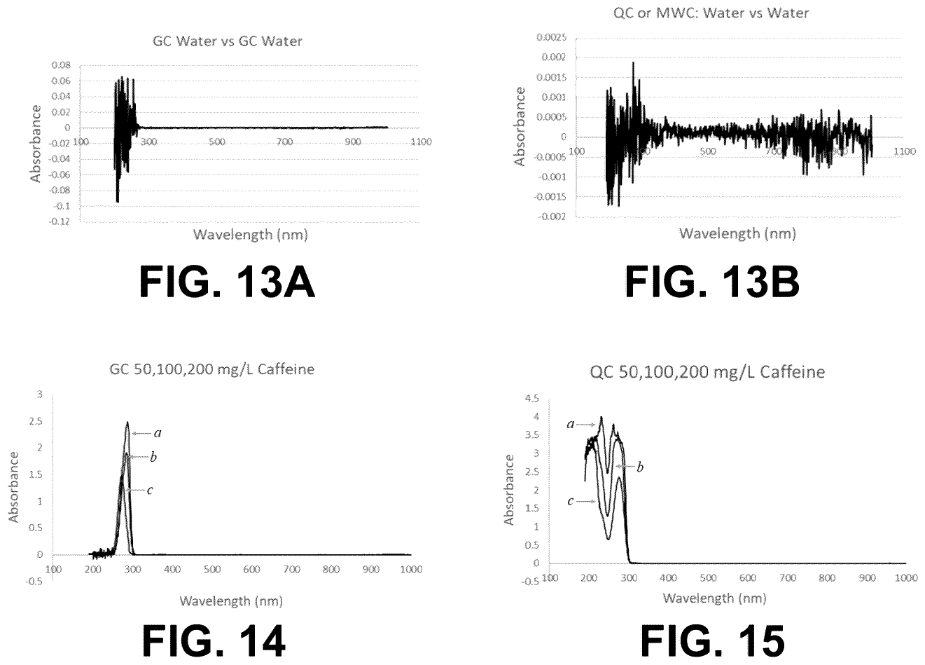

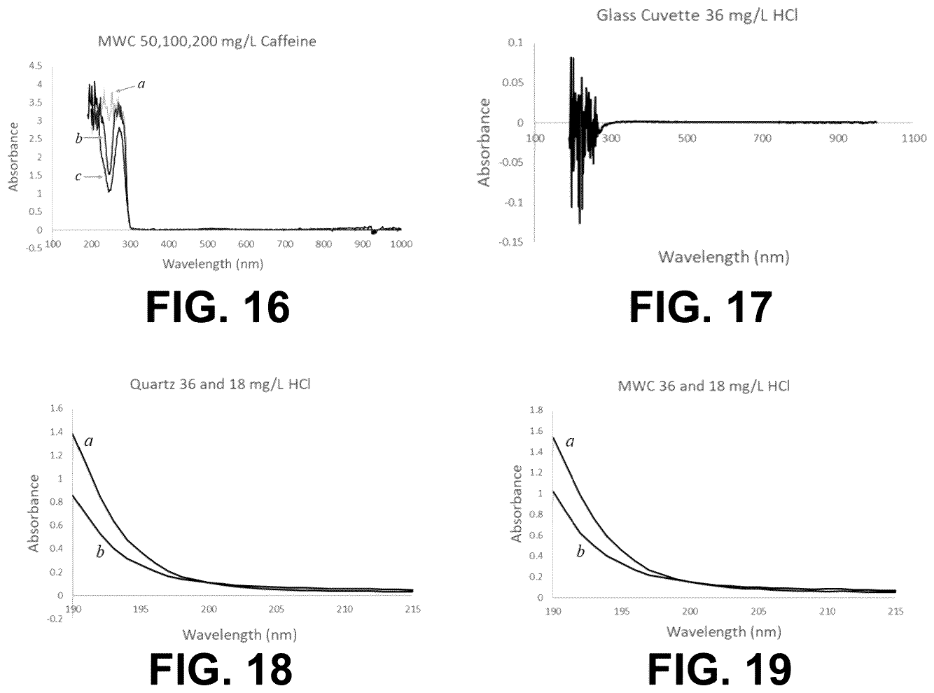

Next is to check a typical calibration setup that tests a pure water sample against a reference pure water to verify a zero background that is free of impurities. A Zero-Calibration was performed on a glass cuvette, quartz cuvette, and the mesh-wire cuvette MWC, FIGS. 13A and 13B. For the glass cuvette GC, the UV-Vis spectrum, FIG. 13A, shows a smooth background signal between 1100 to 250 nm followed by strong fluctuations between 250 and 190 nm where GCs are opaque at the cut-off wavelength of 250 nm. The UV-Vis spectra of the quartz cuvette share a similar noise signal background as the MWC because both cuvettes are transparent to the UV radiation between 250 to 190 nm, FIG. 13B.

Aqueous Sample Analysis: The objective is not to conduct any quantitative analysis on a particular chemical but to demonstrate the capability of the proposed mesh wire cuvette MWC cuvette by comparing its transmissive performance to conventional cuvettes. The three solutions selected show absorption peaks close to the Far UV between 190 to 250 nm and were used to test the performance of the MWC in comparison to the conventional glass cuvette GC and the Quartz cuvette QC. The first solution is a caffeine solution that exhibits two strong absorption peaks across a band from 320 nm to 200 nm. The second solution is a hydrochloric acid solution that exhibits a decaying band in the Far UV between 190 to 215 nm. The third solution is a chromate solution that exhibits two strong peaks at 377 nm and 273 nm.

Using a glass cuvette, Caffeine was tested at three concentration levels 200 ppm, 100 ppm, and 50 ppm, FIG. 14 a,b,c, respectively. A single spectral peak with a maximum absorbance λₘₐₓ ˜2.5 appears at λₘₐₓ=284 nm. As expected, there is a cut-off wavelength at 250 nm making a noisy region between 250 to 200 nm. The caffeine solution was diluted to 100 ppm and 50 ppm to produce the peaks in FIG. 14b,c.

The Caffeine solutions were tested using the Quartz cuvette QC. Two dominant spectral peaks showing slight saturation with absorbance λₘₐₓ ˜3.5 appear at λₘₐₓ₁=277 nm and λₘₐₓ₂=208 nm. The peak at 277 nm shows higher absorbance when the QC is compared to the GC at the three concentration levels of 200 mg/L, 100 mg/L, and 50 mg/L, FIG. 15a,b,c, respectively. Among the three peaks, the QC exhibited ˜1.5 times higher peak-to-peak ratio than the GC. A diluted caffeine solution of 50 ppm removed the saturation thus making it easier to compare peak heights, FIG. 15c.

When the Caffeine solutions were tested using the mesh wire cuvette MWC, absorbance was enhanced. Instead of two prominent peaks at 200 mg/L as with the QC, the MWC displayed one strong saturated peak that spanned the region from 320 nm to 190 nm. This is a sign of greater sensitivity displayed by the MWC. The two peaks at λₘₐₓ1=277 nm and λₘₐₓ₂=208 nm but using a concentration of 100 mg/L showed greater saturation compared to those peaks by the QC. Using the peak at 277 nm that corresponds to the 50 mg/L solution, the MWC showed a 1.9 times higher peak-to-peak ratio when compared to GC and 1.3 times when compared to QC. Interestingly, although the blocking effect of the MWC is more than 4 times the conventional cuvettes, the MWC exhibited higher absorbance using the Caffeine solutions.

For the hydrochloric acid solutions of concentrations 36 ppm and 18 ppm, the glass cuvette can hardly display any signal, FIG. 17, because of its cut-off region at 250 nm.

For the hydrochloric acid solutions at 36 ppm and 18 ppm, the Quartz cuvette showed two decaying signals that extended from 220 nm to 190 nm, characteristic of a hydrochloric acid signal, FIG. 18a,b. These signals are used to quantify hydrochloric acid impurities after etching processes [27]. The two signals were detected by the QC, because, unlike glass, the QC does not block Far UV radiation in this region. Such transparency to Far UV allowed us to compare MWC performance to QC performance when an HCl solution is used.

For the hydrochloric acid solutions at 36 ppm and 18 ppm, the MWC cuvette, like the Quartz cuvette, showed two decaying signals that extended from 220 nm to 190 nm, characteristic of a hydrochloric acid signal, FIG. 19a,b. The two signals were detected because the MWC cuvette, unlike glass, does not block Far UV radiation in this region. Comparing the UV-Vis spectra of hydrochloric acid solutions from the Quartz and MWC cuvettes, the % average difference is 16% higher for the MWC cuvette in relation to the 18 mg/L sample and 20% higher for the 36 mg/L sample. Therefore, although the MWC has a greater UV-Vis radiation-blocking effect compared to conventional cuvettes, as demonstrated in FIG. 11, it has a major advantage when it comes to improving the sensitivity of subtracted signals. That is, even when water strongly absorbs in the Far UV from 200 to 100 nm, replacing the QC that strongly absorbs in this region with the MWC that is fully transparent can make Far UV spectroscopy more practical to implement using conventional spectrometers.

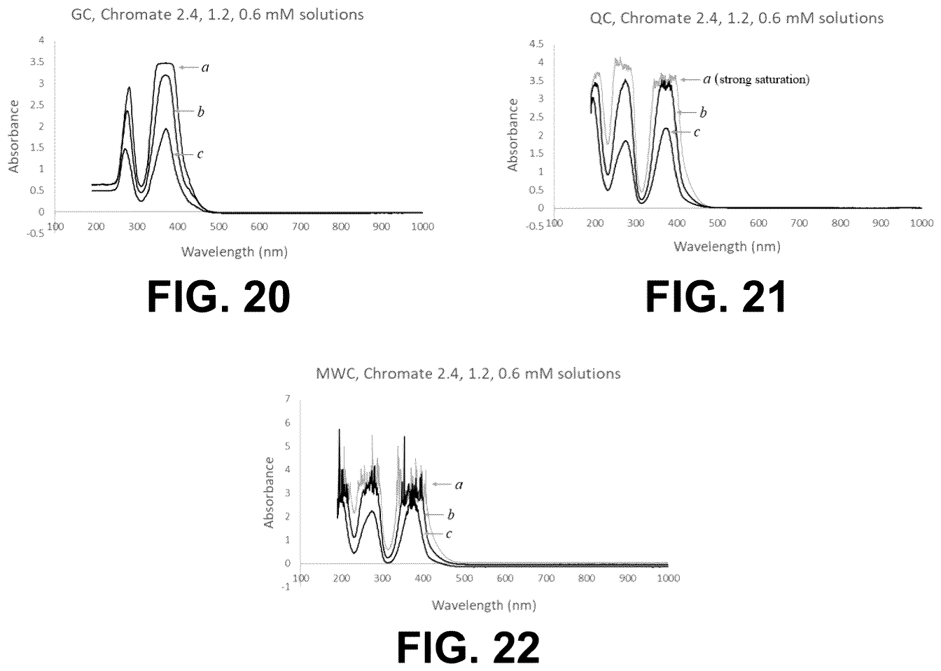

Finally, all cuvettes were tested against a potassium chromate solution K₂CrO₄ of concentrations 0.0024M, 0.0012M, and 0.0006M. The K₂CrO₄ solution exhibits peaks in the visible region thus another measure to test the MWC capability. UV-Vis spectra of K₂CrO₄ solution at 2.4 mM, 1.2 mM, and 0.6 mM using the GC show two dominant peaks at 377 nm and 273 nm, FIG. 20a,b,c. The peak at 377 nm, showed saturation against the 2.4 mM solution and maximum absorbance λₘₐₓ ˜3.2 and 1.84 for the 1.2 mM and 0.6 mM solutions respectively. Wₑ use the 273 nm peak as a reference with λₘₐₓ ˜1.4 for a 0.6 mM solution.

The Chromate solutions were tested using the Quartz cuvette QC. Unlike the GC, two dominant spectral peaks showing slight saturation with absorbance λₘₐₓ ˜3.5 appear at 273 nm and 377 nm region, FIG. 21. The peak at 273 nm shows higher absorbance when the QC is compared to the GC at the two concentration levels of 1.2 mM and 0.6 mM, FIG. 21a,b,c. For the unsaturated peaks, the QC exhibited ˜1.2 times higher peak-to-peak ratio than the GC.

When the Chromate solutions were tested using the mesh wire cuvette MWC, absorbance values were higher. Again, the MWC displayed greater saturation of peaks at both the 2.4 mM and 1.2 mM concentrations, FIG. 22a,b,c. While saturation effects on both peaks at 273 nm and 377 nm disappeared at 2 mM using the QC, the MWC exhibited strong saturation of the peak at 377 nm using 2 mM solution. On average, comparing the values of λₘₐₓ at 273 nm, the MWC exhibited ˜1.5 times higher peak-to-peak ratio than the GC, and 1.2 times peak-to-peak ratio than the QC.

UV-Vis spectra were also obtained at three lower concentrations of 0.3 mM, 0.15 mM, and 0.03 mM. At a concentration of 0.03 mM (i.e. 5.8 mg/L or 5.8 ppm) of K₂CrO₄, the characteristic peaks at 273 nm and 377 nm are still clearly resolvable at λₘₐₓ ˜0.1. With reference to the background noise in the 0.03 mM spectrum, the Evolution 220 can obtain a UV-Vis spectrum of K₂CrO₄ with λₘₐₓ ˜0.03 using the homemade MWC.

### I. REFERENCES

References are cited herein throughout using the format of reference number(s) enclosed by parentheses corresponding to one or more of the following numbered references. For example, citation of references numbers 1 and 2 immediately herein below would be indicated in the disclosure as [1, 2] or [1-2].
[1] D Muhammad Zaman Khan, Jiri Militky, Michal Petrub, Blanka Tomková, Azam Ali, Elçin Tören, Sajida Perveen (2022). Recent advances in superhydrophobic surfaces for practical applications: A review, European Polymer Journal, Volume 178(5).
[2] Xiao Wang, Cheng Fu, Chunlai Zhang, Zhengyao Qiu, and Bo Wang, (2022) A Comprehensive Review of Wetting Transition Mechanism on the Surfaces of Microstructures from Theory and Testing Methods, Materials, 15, 4747.
[3] E. Pakdel, J. Wang, S. Kashi, L. Sun, X. Wang, (2020) Advances in photocatalytic self-cleaning, superhydrophobic and electromagnetic interference shielding textile treatments, Adv. Colloid Interface Sci., 277, 102116.
[4] D. W. Wei, H. Wei, A. C. Gauthier, J. Song, Y. Jin, H. Xiao, (2020), Superhydrophobic modification of cellulose and cotton textiles: Methodologies and applications, J. Bioresour. Bioprod., 5, 1-15.
[5] X. J. Guo, C. H. Xue, M. Li, X. Li, J. Z. Ma, (2017) Fabrication of robust, superhydrophobic, electrically conductive, and UV-blocking fabrics: via layer-by-layer assembly of carbon nanotubes, RSC Adv., 7, 25560-25565.
[6] Y. Zhao, Y. Tang, X. Wang, T. Lin, (2010) Superhydrophobic cotton fabric fabricated by electrostatic assembly of silica nanoparticles and its remarkable buoyancy, Appl. Surf. Sci. 256, 6736-6742.
[7] J. Bravo, L. Zhai, Z. Z. Wu, R. E. Cohen, M. F. Rubner, (2007) Transparent superhydrophobic films based on silica nanoparticles, Langmuir, 23, 7293.
[8] Konica Sharma, Amrita Hooda, M. S. Goyat, Radheshyam Rai, Ajay Mittal, (2022) A review on challenges, recent progress and applications of silica nanoparticles based superhydrophobic coatings, Ceramics International, 48, 5922-5938.
[9] Zhiqian Wang, Sumona Paul, Louis H. Stein, Arash Salemi, and Somenath Mitra, (2022) Recent Developments in Blood-Compatible Superhydrophobic Surfaces, Polymers, 14, 1075.
[10] Ik-Soo Kim, Myung-Yeon Cho, Yohan Jeong, Yun-Cheol Shin, Dong-Won Lee, Chulhwan Park, Sang-Mo Koo, Weon Ho Shin, Won-Jik Yang, Yeol Park, Hiesang Sohn, Jong-Min O. (2021) Aerosol-deposited Al₂O₃/PTFE hydrophobic coatings with adjustable transparency, J Am Ceram Soc.; 104: 1716-1725.
[11] Wang, Feng; Zhang, Huapeng; Zhu, Hailin; Guo, Yuhai; (2014) Ultra-hydrophobic modification of TiO2 nanoparticles via thermal decomposition of polytetrafluoroethylene, Powder Technology, Volume 253, Pages 548-552.
[12] Inoue, Youichi; Yoshimura, Yasuhiro; Ikeda, Yukiko; Kohno, Akiomi; (2000) Ultra-hydrophobic fluorine polymer by Ar-ion bombardment, Colloids and Surfaces B: Biointerfaces, Volume 19, Issue 3, 30, Pages 257-261.
[13] Joanna Piwowarczyk, Roman Jedrzejewski, Dariusz Moszy ‘nski, Konrad Kwiatkowski, Agata Niemczyk, Jolanta Baranowska, (2019) XPS and FTIR Studies of Polytetrafluoroethylene Thin Films Obtained by Physical Methods, Polymers, 11, 1629.
[14] Daniel G. Abebe, Tarek R. Farhat* (2010) “Self-assembly of Nation®/poly(vinyl alcohol) at pH=1.2 and Nafion®/poly(allyl amine) at pH=11, Soft Matter, vol. 6, issue 6, pp. 1325.
[15] Xiao Wang, Cheng Fu, Chunlai Zhang, Zhengyao Qiu, and Bo Wang,*, A Comprehensive Review of Wetting Transition Mechanism on the Surfaces of Microstructures from Theory and Testing Methods, (2022) Materials 15(14): 4747.
[16] Zhang J, Li J, Han Y. (2004) Superhydrophobic PTFE surfaces by extension. Macromolecular Rapid Communications. 1; 25(11): 1105-8.
[17] Reese, L. C., and Welch, R. C., 1975, Lateral loading of deep foundations in stiff clay., J. Geotech. Engrg. Div., 101(7), 633-649.
[21] Understanding Cuvette Volume, Material, Path Length etc., Cuvet.co. Webpage.
[22] Spectrophotometer Quartz Cuvettes for UV Range, Aireka Cells. Webpage. UV-vis Spectrophotometer Cuvette Selection Guide, Aireka Cells. Webpage
[23] Far UV, Vacuum UV, and UV Optical Properties of Materials, eSource Optics. Webpage.
[24] Principles of Instrumental Analysis 7th Edition, by Douglas A. Skoog, F. James Holler, Stanley R. Crouch, Cengage Learning; 7th edition (Jan. 1, 2017), Chapter 13, page-337-, ISBN-13: 978-1305577213
[25] Jarnutowski, J. R. Ferraro, D. C. Lankin, Spectroscopy, 1992, 7 (7), 22.
[26] M. Fouchier, E. Pargon, L. Azarnouche, K. Menguelti, O. Joubert, T. Cardolaccia, Y. C. Bae, Vacuum ultraviolet absorption spectroscopy of 193 nm photoresists, Appl Phys A (2011) 105:399-405, DOI 10.1007/s00339-011-6553-3
[27] Yukihiro Ozaki, Yusuke Morisawa, Akifumi Ikehata, and Noboru Higashi, Far-Ultraviolet Spectroscopy in the Solid and Liquid States: A Review, Applied Spectroscopy Vol. 66, Issue 1, pp. 1-25 (2012).
[28] Yukihiro Ozaki, Frontiers of Far-Ultraviolet Spectroscopy in the Solid and Liquid States, Spectroscopy, 2017, Volume 32, Issue 2, Pages: 40-51
[29] N. Higashi and Y. Ozaki, Appl. Spectrosc. 58, 910 (2004)
[30] V. D. Noto and M. Mecozzi, Appl. Spectrosc., 9, 1294 (1997)
[31] Tarek R. Farhat, Hasan El Rifai, Rana Jisr, Evelyn Patterson, Emily H Santamaria, Deposition/Characterization of an ultrathin film of Polyallylamine/polytetrafluoroethylene Colloid Coating on Metallic Substrates, American Journal of Materials Science, 2023; 2023, 13(1): 1-6.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A coated metal comprising:
a metal substrate; and
a superhydrophobic coating comprising a bilayer coating comprising a first layer and a second layer;
wherein the first layer comprises a polyelectrolyte;
wherein the second layer comprises particles of polytetrafluoroethylene;
wherein the first layer is deposited on the metal substrate; and
wherein the second layer is deposited on the first layer.

2. The coated metal of claim 1, wherein the metal substrate comprises a solid surface.

3. The coated metal of claim 1, wherein the metal substrate comprises a mesh.

4. The coated metal of claim 1, wherein the mesh is a mesh #120, 70, 38, 16, or combinations thereof.

5. The coated metal of claim 1, wherein the metal substrate comprises aluminum, iron, copper, zinc, silver, gold, tin, combinations of the foregoing, and/or alloys comprising one or more of the foregoing.

6. The coated metal of claim 1, wherein the polyelectrolyte is selected from polyamine, polyethyleneimine (PEI), and combinations thereof.

7. The coated metal of claim 1, wherein the bilayer coating has an average thickness of from about 0.1 μm to about 10 μm.

8. The coated metal of claim 1, wherein the second layer is a colloidal layer comprising particles of polytetrafluoroethylene.

9. The coated metal of claim 8, wherein the particles of polytetrafluoroethylene have an average diameter of from about 0.1 μm to about 10 μm.

10. The coated metal of claim 1, wherein the first layer has an average thickness of from about 0.1 nm to about 50 nm.

11. The coated metal of claim 1, wherein the second layer has a thickness of from about 0.1 μm to about 10 μm.

12. The coated metal of claim 1, wherein the coated metal has a contact angle of at least about 125° when determined using a sessile drop of water on the superhydrophobic coating of the coated metal.

13. The coated metal of claim 1, wherein the superhydrophobic coating comprises more than one bilayer coating sequentially layered on one another.

14. A method of making the coated metal of claim 1, the method comprising the steps of:
forming a superhydrophobic coating comprising a first layer and a second layer;
wherein the forming the superhydrophobic coating comprises depositing the first layer on the metal substrate;
wherein the forming the superhydrophobic coating comprises depositing the second layer on the first layer;
wherein the first layer comprises a polyelectrolyte;
wherein the second layer comprises particles of polytetrafluoroethylene;
wherein the depositing the first layer on the metal substrate comprises contacting the metal substrate with a solution of the polyelectrolyte comprising:
from about 1 mM to about 100 mM of the polyelectrolyte; and
from about 1 mM to about 1000 mM salt;
wherein the depositing the second layer on the first layer comprises contacting the metal substrate comprising the first layer with a colloidal solution of the polytetrafluoroethylene; and
wherein the colloidal solution of the polytetrafluoroethylene comprises about 1 wt % to about 60 wt % of the polytetrafluoroethylene.

15. The method of claim 14, wherein the contacting the metal substrate with the solution of the polyelectrolyte comprises spraying, dipping, flowing, or combinations thereof the solution of the polyelectrolyte onto the metal substrate.

16. The method of claim 14, wherein the contacting the metal substrate comprising the first layer with a colloidal solution of the polytetrafluoroethylene comprises spraying, dipping, flowing, or combinations thereof the colloidal solution of the polytetrafluoroethylene onto the metal substrate comprising the first layer.

17. The method of claim 14, wherein prior to the contacting the metal substrate with the solution of the polyelectrolyte, the metal substrate is pre-treated as follows:
rinsed with a solvent;
treated with an oxidant solution; and
plasma etched.

18. A product comprising the coated metal of claim 1 or a coated metal prepared by the method of claim 14.

19. An apparatus, comprising:
a base;
a first wall, wherein the first wall extends perpendicularly from the base;
a second wall, wherein the second wall extends perpendicularly from the base and is parallel with the first wall;
a third wall, wherein the third wall extends perpendicularly from the base and extends between the first wall and the second wall;
and a fourth wall, wherein the fourth wall extends perpendicularly from the base, extends between the first wall and the second wall, and is parallel to the third wall;
wherein,
a portion of the first wall comprises a first opening covered by a first mesh wire;
a portion of the second wall comprises a second opening covered by a second mesh wire, wherein the first opening is aligned with the second opening;
wherein the first mesh wire comprises a superhydrophobic or superamphiphobic coating; and
wherein the second mesh wire comprises a superhydrophobic or superamphiphobic coating.
